(19) United States
(12) Patent Application Publication
(10) Pub. No.: US 2013/0308697 A1
(43) Pub. Date: Nov. 21, 2013

(54) IMAGE PROCESSING APPARATUS, IMAGE PROCESSING METHOD, AND PROGRAM

(71) Applicant: Sony Corporation, Tokyo (JP)

(72) Inventor: Takahiro Fukuhara, Kanagawa (JP)

(73) Assignee: Sony Corporation, Tokyo (JP)

(21) Appl. No.: 13/891,367

(22) Filed: May 10, 2013

(30) Foreign Application Priority Data
May 18, 2012 (JP) 2012-114679

(51) Int. Cl. H04N 7/26

(52) U.S. Cl. CPC H04N 19/00169
USPC 375/240.02

(57) ABSTRACT

Provided is an image processing apparatus, including: a first encoder section configured to encode some frames of image data, to thereby create first encoded data; a rate controlling section configured to control a bit rate of the first encoded data created by the first encoder section, to thereby create low-frame-rate encoded data having a first bit rate and second encoded data having a second bit rate, the second bit rate being different from the first bit rate; a second encoder section configured to encode the frames of the image data, the frames being other than the frames encoded by the first encoder section, to thereby create third encoded data having the second bit rate; and an integrating section configured to integrate the second encoded data created by the rate controlling section and the third encoded data created by the second encoder section, to thereby create high-frame-rate encoded data.

### BACKGROUND

The present disclosure relates to an image processing apparatus, an image processing method, and a program. Specifically, the present disclosure relates to an image processing apparatus, an image processing method, and a program, each of which is capable of creating encoded data of a plurality of kinds of frame rates from one piece of image data or from encoded data thereof, easily.

DCI (Digital Cinema Initiative) standard is a de facto international standard of digital cinema. Conventionally, according to DCI standard, it is determined that the frame rate of 2K×1K resolution is 24 P or 48 P, and that the frame rate of 4 k×2K resolution is 24 P.

Conventionally, 24 P files for a low frame rate (LFR) were treated independently of 48 P files for a high frame rate (HFR). Because of this, in a case where a movie theater or the like uses both a movie for LFR and an HFR movie, it is necessary to prepare both files.

Generally, image data is encoded, and the encoded image data is stored, to thereby reduce the volume (for example, see Japanese Patent Application Laid-open No. 2004-166254). LFR encoded data and HFR encoded data are created from one piece of image data. In this case, if LFR encoded data and HFR encoded data are created independently, some frame images may be encoded twice. Because of such a redundant process, a load may be increased unnecessarily. In view of this, there is proposed a method of extracting data of frames corresponding to LFR from HFR encoded data, to thereby create LFR encoded data. In this case, an image of each frame is encoded only once. Because of this, according to this method, it is possible to inhibit unnecessary increase of a load of an encoding process, compared to a case of independently creating LFR encoded data and HFR encoded data from one piece of image data.

### SUMMARY

However, the bit rate required for LFR encoded data may sometimes be different from the bit rate required for HFR encoded data. In this case, according to the above-mentioned method of simply extracting LFR encoded data from HFR encoded data, the required bit rate condition may not be satisfied, and this method may not be realized.

In view of the above-mentioned circumstances, it is desirable to create encoded data of a plurality of kinds of frame rates from one piece of image data or from encoded data thereof, easily.

According to an aspect of the present technology, there is provided an image processing apparatus, including: a first encoder section configured to encode some frames of image data, to thereby create first encoded data; a rate controlling section configured to control a bit rate of the first encoded data created by the first encoder section, to thereby create low-frame-rate encoded data having a first bit rate and second encoded data having a second bit rate, the second bit rate being different from the first bit rate; a second encoder section configured to encode the frames of the image data, the frames being other than the frames encoded by the first encoder section, to thereby create third encoded data having the second bit rate; and an integrating section configured to integrate the second encoded data created by the rate controlling section and the third encoded data created by the second encoder section, to thereby create high-frame-rate encoded data.

The bit rate may be a bit amount for each frame.

The rate controlling section may be configured to as necessary round down a part of the first encoded data of each frame, to thereby control the bit amount for each frame.

The rate controlling section may be configured to round down the first encoded data of each frame by a necessary amount from the least important side in the ascending order.

The first encoder section may include a transforming section configured to transform the image data of a part of frame into coefficient data for each frequency band, and a bit plane encoder section configured to encode the coefficient data obtained by the transforming section for each bit plane, the bit plane being created for a predetermined number of pieces of the coefficient data, the bit plane being a set of values at the same bit position, and the rate controlling section may be configured to round down a necessary number of bit planes of the first encoded data from the bottom in ascending order.

The first encoder section may further include a code-block creating section configured to create a code block, the code block including a predetermined number of pieces of the coefficient data obtained by the transforming section, and a bit-plane creating unit configured to create the bit plane for each code block created by the code-block creating section, and the bit plane encoder section may be configured to round down a necessary number of bit planes of the code block created by the bit-plane creating unit from the bottom in ascending order.

The second encoder section may be configured to encode the image data by means of an encoding system similar to the first encoder section.

Each of the first encoder section and the second encoder section may be configured to encode frames of the image data by means of JPEG 2000 system.

The first encoder section may be configured to set a layer of a coding pass based on the first bit rate and the second bit rate, and the rate controlling section may be configured to round down a necessary number of layers, to thereby control a bit rate of the first encoded data, and to thereby create the low-frame-rate encoded data and the second encoded data.

The image processing apparatus may further include: a frame distributing section configured to distribute some frames of the image data to the first encoder section based on a preset frame rate, and to distribute the other frames to the second encoder section.

The frame distributing section may be configured to add identification information to at least one of the frames distributed to the first encoder section and the frames distributed to the second encoder section, the identification information identifying a distribution-target group.

The image processing apparatus may further include: storage configured to store the low-frame-rate encoded data created by the rate controlling section.

According to another aspect of the present technology, there is provided an image processing method performed by an image processing apparatus, including: by the image processing apparatus, encoding some frames of image data, to thereby create first encoded data; controlling a bit rate of the created first encoded data, to thereby create low-frame-rate encoded data having a first bit rate and second encoded data having a second bit rate, the second bit rate being different from the first bit rate; encoding the other frames of the image data, to thereby create third encoded data having the second bit rate; and integrating the created second encoded data and the created third encoded data, to thereby create high-frame-rate encoded data.

According to another aspect of the present technology, there is provided a program, configured to cause a computer to function as: a first encoder section configured to encode some frames of image data, to thereby create first encoded data; a rate controlling section configured to control a bit rate of the first encoded data created by the first encoder section, to thereby create low-frame-rate encoded data having a first bit rate and second encoded data having a second bit rate, the second bit rate being different from the first bit rate; a second encoder section configured to encode the frames of the image data, the frames being other than the frames encoded by the first encoder section, to thereby create third encoded data having the second bit rate; and an integrating section configured to integrate the second encoded data created by the rate controlling section and the third encoded data created by the second encoder section, to thereby create high-frame-rate encoded data.

According to another aspect of the present technology, there is provided an image processing apparatus, including: a selecting section configured to select data for each frame from encoded data at a ratio corresponding to a frame rate, the encoded data being obtained by encoding image data, to thereby create encoded data of a plurality of frame rates; and a rate controlling section configured to use each target bit rate as a bit rate of encoded data of each frame rate, the encoded data being created by the selecting section.

The image processing apparatus may further include: a determining section configured to determine the target bit rate, and the rate controlling section may be configured to use a bit rate of encoded data of each frame rate as a target bit rate determined by the determining section.

The image processing apparatus may further include: an encoder section configured to encode the image data, to thereby create the encoded data, and the selecting section may be configured to create encoded data of a plurality of frame rates from the encoded data created by the encoder section.

The image processing apparatus may further include: a decoder section configured to decode encoded data of each frame rate, the each frame rate being controlled at each target bit rate by the rate controlling section.

According to another aspect of the present technology, there is provided an image processing method performed by an image processing apparatus, including: by the image processing apparatus, selecting data for each frame from encoded data at a ratio corresponding to a frame rate, the encoded data being obtained by encoding image data, to thereby create encoded data of a plurality of frame rates; and using each target bit rate as a bit rate of the created encoded data of each frame rate.

According to another aspect of the present technology, there is provided a program, configured to cause a computer to function as: a selecting section configured to select data for each frame from encoded data at a ratio corresponding to a frame rate, the encoded data being obtained by encoding image data, to thereby create encoded data of a plurality of frame rates; and a rate controlling section configured to use each target bit rate as a bit rate of encoded data of each frame rate, the encoded data being created by the selecting section.

According to another aspect of the present technology, some frames of image data are encoded, to thereby create first encoded data; a bit rate of the created first encoded data is controlled, to thereby create low-frame-rate encoded data having a first bit rate and second encoded data having a second bit rate, the second bit rate being different from the first bit rate; the other frames of the image data are encoded, to thereby create third encoded data having the second bit rate; and the created second encoded data and the created third encoded data are integrated, to thereby create high-frame-rate encoded data.

According to another aspect of the present technology, data is selected for each frame from encoded data at a ratio corresponding to a frame rate, the encoded data being obtained by encoding image data, to thereby create encoded data of a plurality of frame rates; and each target bit rate is used as a bit rate of the created encoded data of each frame rate.

According to the present technology, an image is processed. Specifically, it is possible to create encoded data of a plurality of kinds of frame rates from one piece of image data or from encoded data thereof, easily.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a main configuration example of an image encoding apparatus.

FIG. 2 is a diagram for explaining a relation of a picture array of LFR and HFR;

FIG. 3 is a diagram showing a main configuration example of an LFR encoder section;

FIG. 4 is a diagram showing a configuration example of subbands;

FIG. 5 is a diagram showing a configuration example of subbands;

FIG. 6 is a diagram showing an example of code blocks in each subband;

FIG. 7 is a diagram for explaining an example of a bit plane;

FIG. 8 is a diagram for explaining an example of coding passes;

FIG. 9 is a diagram for explaining an example of scanning coefficients;

FIG. 10 is a diagram for explaining layers;

FIG. 11 is a diagram for explaining a configuration example of layers;

FIG. 12 is a diagram for explaining a progression function;

FIG. 13 is a diagram for explaining another example of a progression function;

FIG. 14 is a diagram for explaining an example of rate control;

FIG. 15 is a flowchart for explaining a plural FRs encoding process flow;

FIG. 16 is a flowchart for explaining an example of an encoding process flow;

FIG. 17 is a block diagram showing a main configuration example of an image encoding apparatus;

FIG. 18 is a flowchart for explaining an example of a plural FRs encoding process flow;

FIG. 19 is a block diagram showing a main configuration example of an image decoding apparatus;

FIG. 20 is a block diagram showing a main configuration example of an LFR decoder section;

FIG. 21 is a flowchart for explaining an example of the flow of plural FRs decoding process;

FIG. 22 is a flowchart for explaining an example of the flow of decoding process;

FIG. 23 is a diagram showing a configuration example of a COD marker segment;

FIG. 24 is a diagram showing an example of an Scod parameter; and

FIG. 25 is a block diagram showing a main configuration example of a computer.

### DETAILED DESCRIPTION OF EMBODIMENTS

Hereinafter, embodiments of the present disclosure will be described with reference to the drawings. Note that description will be made in the following order.

1. First embodiment (image encoding apparatus)

2. Second embodiment (image encoding apparatus)

3. Third embodiment (image decoding apparatus)

4. Fourth embodiment (application)

5. Fifth embodiment (computer)

### 1. First Embodiment

[1-1 Redundant Process]

DCI (Digital Cinema Initiative) standard is a de facto international standard of digital cinema. According to DCI standard, it is determined that the frame rate of 2K×1K resolution is 24 P or 48 P, and that the frame rate of 4 k×2K resolution is 24 P. Conventionally, 24 P files for low frame rate (LFR) were treated independently of 48 P files for high frame rate (HFR). Because of this, in a case where a movie theater or the like shows both an LFR movie and an HFR movie, it is necessary to prepare both files.

However, in this case, the only difference between both files is frame rates. Because of this, both files may include the same frames. That is, both files are extremely redundant. Unnecessary memory capacity is required to store both files simultaneously.

Specifically, the data volume of moving image data is large. Generally, moving image data is encoded, and the encoded moving image data is stored, to thereby reduce the volume, in most cases. However, the data volume of the encoded data is still large. For example, the data volume of JPEG 2000-encoded data, which is encoded with 250 Mbps (DCI standard), of two hours is 1,800 Gbytes (1.8 TB) (250 Mbps×3,600 seconds×2 hours=1,800). In view of this, it is desirable to reduce the above-mentioned redundancy as much as possible.

In view of this, there is proposed a method of storing the frame, which is common to LFR and HFR, for one of LFR and HFR, and not storing the same frame for the other of LFR and HFR. For example, let's say the frames for HFR include all the frames for LFR. In this case, data for HFR is only stored. If data for LFR is to be used, necessary part of data for HFR is extracted, to thereby create data for LFR. As a result, it is possible to reduce redundancy, and to reduce unnecessary increase of data volume.

However, in some cases, the bit rate (target bit rate) required for data for LFR is different from the bit rate (target bit rate) required for data for HFR. Further, the frame rate for LFR is different from the frame rate for HFR. So, even if the bit rate for LFR is the same as the bit rate for HFR, the bit amount (target bit amount) required for one frame for LFR may be different from the bit amount (target bit amount) required for one frame for HFR.

The target bit amount for one frame is determined based on the required bit rate and frame rate. Because of this, the target bit amount for one frame is different depending on the required bit rate and frame rate. For example, in some cases, the target bit amount for LFR may be larger than the target bit amount for HFR. In other cases, the target bit amount for LFR may be smaller than the target bit amount for HFR.

As described above, the target bit rate for LFR may be different from the target bit rate for HFR. In this case, if the same data is used for LFR and HFR, the image quality of a reproduced image may be decreased.

For example, let's say that, as described above, the frames for HFR include all the frames for LFR, and data for LFR is extracted from data for HFR. In this case, the target bit amount for LFR is used as the target bit amount of the frame common to LFR and HFR. Then, there is no problem in an LFR reproduced image. However, the bit amount for each frame varies in an HFR reproduced image. A viewer may have a feeling of strangeness in his eyesight, and may think that the image quality is degraded.

To the contrary, let's say that the target bit amount for HFR is used as the target bit amount of the frame common to LFR and HFR. Then, there is no problem in an HFR reproduced image. However, for example, let's say that the target bit amount for one LFR frame is larger than the target bit amount for one HFR frame. In this case, the bit rate for LFR is decreased unnecessarily. The image quality of an LFR reproduced image is thus decreased unnecessarily. To the contrary, let's say that the target bit amount for one LFR frame is less than the target bit amount for one HFR frame. In this case, the bit rate for LFR is larger than the target bit rate. As a result, for example, delay time in data transmission or the like may not be permissive, which is inconvenient.

As a result, it is necessary to adjust the rate of each image data. In order to adjust the rate of each image data, it is necessary to encode or decode data of each common frame, in the end. Processing redundancy is thus increased. As a result, unnecessary load is increased, and it may be difficult to realize this method. Specifically, let's say that transmitted data is reproduced immediately (in real time). In this case or other cases, it is necessary to reduce delay time of processing such as encoding or decoding. It may thus be further difficult to realize this method.

[1-2 To Create Encoded Data of Plurality of Frame Rates]

In view of the above, some frames in image data are encoded, to thereby create first encoded data. The bit rate of the first encoded data is controlled, to thereby create low-frame-rate encoded data of the first bit rate. In addition, second encoded data of a second bit rate is created. The second bit rate is different from the first bit rate. The frames in the image data, which are not included in the first encoded data, are encoded, to thereby create third encoded data of a second bit rate. The frames of the second encoded data are integrated with the frames of the third encoded data, to thereby create high-frame-rate encoded data.

As a result, an image processing apparatus is capable of decreasing redundancy of encoding or decoding, which has a large load. That is, the image processing apparatus is capable of creating encoded data of a plurality of kinds of frame rates from one piece of moving image data easily.

Note that the above-mentioned bit rate is the bit amount of one frame. As a result, the bit amount of one frame is the same as the bit amount of another frame. It is possible to reduce a feeling of strangeness in the eyesight of a viewer, who watches the reproduced image.

Note that, in the rate control, a part of the first encoded data of each frame may be rounded down as necessary, to thereby control the bit amount of one frame. As a result, it is possible to easily control the bit rate of encoded data.

Further, in the rate control, a part of the first encoded data of each frame may be rounded down by a necessary amount in the order of unnecessity. For example, image data of some frames may be transformed into coefficient data of each frequency band. The obtained coefficient data may be encoded, to thereby obtain bit planes. The bit plane is created for each predetermined number of pieces of coefficient data, and is a set of values at the same bit position. The necessary number of bit planes may be rounded down from the bottom in ascending order. As a result, more important data may not be rounded down in order to control rates. The image quality may not be degraded due to rate control.

Further, when encoding, code blocks may be created. The code block is a set of the predetermined number of pieces of coefficient data. A bit plane may be created for each code block. In this case, when adjusting rates, the necessary number of bit planes for each code block are rounded down from the bottom in ascending order. As a result, desired rate control may be performed easily.

Note that encoding for creating the first encoded data may employ one encoding system, and encoding for creating the third encoded data may employ the similar encoding system. As a result, the second encoded data and the third encoded data are integrated easily. Further, JPEG 2000 system may be employed to create such encoded data. According to JPEG 2000 system, each frame is encoded independently. As a result, rate is easily controlled for each frame unit, frames are easily integrated, and the like. Further, the rate of encoded data may be easily controlled (described later).

Further, in encoding, layers of coding pass may be set based on the first bit rate and the second bit rate. The necessary number of layers may be rounded down, to thereby control the bit rate of the first encoded data. As a result, the low-frame-rate encoded data and the second encoded data may be created. Because of this, rates may be controlled easily.

Respective frames of image data may be sorted based on a preset frame rate. Further, in such sorting, identification information for identifying a group may be added to at least one of the respective frames to be sorted. As a result, in a case of extracting some frames from data, in which frames are integrated, the identification information may be used, and process is performed easily.

The low-frame-rate encoded data, which is created by a rate controlling section, may be stored.

Further, data may be selected for each frame from encoded data, which is obtained by encoding image data, at a ratio depending on frame rate. As a result, encoded data of a plurality of frame rates may be created. The bit rate of the created encoded data of each frame rate may be set to each target bit rate. As a result, encoded data of a plurality of kinds of frame rates may be created from one piece of moving image data easily.

Further, a target bit rate may be determined. As a result, transform into arbitrary target bit rate may be performed easily.

Further, image data may be encoded to thereby create encoded data. Encoded data controlled to have a target bit rate may be decoded.

As a matter of course, those processes may be realized by using software.

[1-3 Image Encoding Apparatus]

Hereinafter, a more specific example will be described.

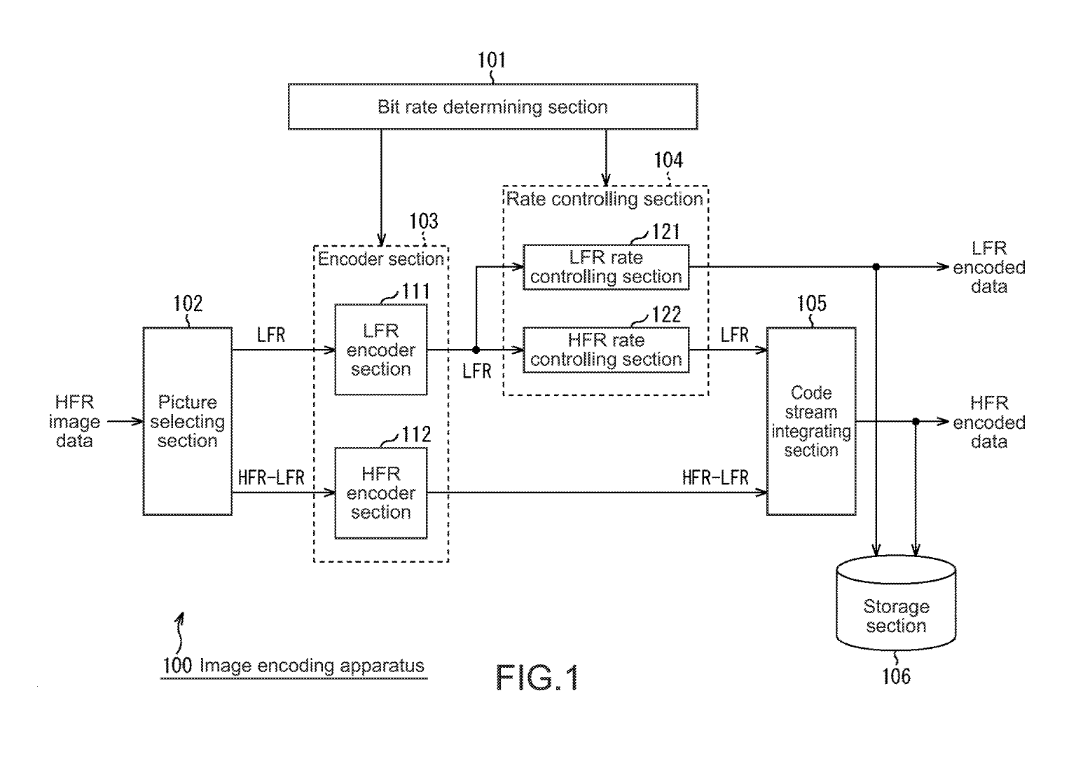

FIG. 1 is a block diagram showing a main configuration example of an image encoding apparatus. An image encoding apparatus 100 shown in FIG. 1 is an image processing apparatus, to which the present technology is applied. The image encoding apparatus 100 encodes input moving image data (HFR image data) of high frame rate (HFR), to thereby create encoded data of high frame rate (HFR). Further, the image encoding apparatus 100 creates encoded data of low frame rate (LFR) by using encoded data of some frames of the HFR image data.

At this time, the image encoding apparatus 100 is capable of easily creating both HFR encoded data of a desired bit rate, and LFR encoded data of a desired bit rate.

As shown in FIG. 1, the image encoding apparatus 100 includes a bit rate determining section 101, a picture selecting section 102, an encoder section 103, a rate controlling section 104, a code stream integrating section 105, and a storage section 106.

The bit rate determining section 101 determines an LFR target bit rate and an HFR target bit rate. The bit rate determining section 101 supplies control information, which indicates the determined LFR target bit rate and the determined HFR target bit rate, to the encoder section 103 and the rate controlling section 104. The bit rate determining section 101 controls behaviors of the encoder section 103 and behaviors of the rate controlling section 104.

The picture selecting section 102 controls, for each picture, where to supply the input image data (HFR image data) of high frame rate. The picture selecting section 102 supplies image data of frames (frames common to LFR and HFR) (LFR) of low frame rate (LFR) to an LFR encoder section 111. The picture selecting section 102 supplies image data of the other frames (frames of HFR) (HFR-LFR) to an HFR encoder section 112.

The encoder section 103 encodes image data of each frame, which is supplied from the picture selecting section 102, by means of, for example, JPEG 2000 system. The encoder section 103 encodes the image data by using the target bit rates, which are determined by the bit rate determining section 101. For example, as shown in FIG. 1, the encoder section 103 includes the LFR encoder section 111 and the HFR encoder section 112.

The LFR encoder section 111 encodes image data (LFR) of frames common to LFR and HFR, which is supplied from the picture selecting section 102. At this time, the LFR encoder section 111 encodes the image data by using a target value. Here, the target value is the higher bit rate of the LFR bit rate and the HFR bit rate, which are determined by the bit rate determining section 101, or is a bit rate higher than that. The LFR encoder section 111 supplies the created encoded data (LFR) to the rate controlling section 104.

The HFR encoder section 112 encodes image data (HFR-LFR) of frames of HFR, which is supplied from the picture selecting section 102. At this time, the HFR encoder section 112 encodes image data by using a target value. Here, the target value is the HFR bit rate, which is determined by the bit rate determining section 101. The HFR encoder section 112 supplies the created HFR encoded data (HFR-LFR) to the code stream integrating section 105.

The rate controlling section 104 as necessary controls the bit rate of the encoded data (LFR), which is supplied from the LFR encoder section 111, for each frame. That is, the rate controlling section 104 as necessary adjusts the bit amount of the encoded data for each frame. For example, the rate controlling section 104 controls the rate of the encoded data by using the target bit rate, which is determined by the bit rate determining section 101.

The rate controlling section 104 rounds down an unnecessary part of the encoded data, to thereby control the rate (details are described later). That is, the rate controlling section 104 controls the volume of data, which is rounded down, to thereby control the rate. Because only a part of encoded data is rounded down, the load of the rate control process may be extremely small. That is, the rate controlling section 104 is capable of controlling the rate easily.

The rate controlling section 104 controls the bit rate of the encoded data of the common frames, to thereby create LFR encoded data and HFR encoded data. The rate controlling section 104 outputs the created LFR encoded data to the outside of the image encoding apparatus 100. Alternatively, the rate controlling section 104 supplies the created LFR encoded data to the storage section 106, and the storage section 106 stores the LFR encoded data. Further, the rate controlling section 104 supplies the created HFR encoded data to the code stream integrating section 105.

The rate controlling section 104 as necessary controls the rate by using at least one of the LFR target bit rate and the HFR target bit rate, which are determined by the bit rate determining section 101.

For example, the LFR encoder section 111 encodes image data, where the LFR target bit rate is a target value. In this case, the rate controlling section 104 treats the encoded data as LFR encoded data. Further, the rate controlling section 104 transforms the bit rate of the encoded data into the HFR target bit rate, to thereby create HFR encoded data.

Further, for example, the LFR encoder section 111 encodes image data, where the HFR target bit rate is a target value. In this case, the rate controlling section 104 treats the encoded data as HFR encoded data. Further, the rate controlling section 104 transforms the bit rate of the encoded data into the LFR target bit rate, to thereby create LFR encoded data.

Further, for example, the LFR encoder section 111 encodes image data, where a bit rate higher than the LFR target bit rate and the HFR target bit rate is a target value. In this case, the rate controlling section 104 transforms the bit rate of the encoded data into the LFR target bit rate, to thereby create the LFR encoded data. In addition, the rate controlling section 104 transforms the bit rate of the encoded data into the HFR target bit rate, to thereby create HFR encoded data.

As shown in FIG. 1, the rate controlling section 104 includes, for example, an LFR rate controlling section 121 and an HFR rate controlling section 122.

The LFR rate controlling section 121 as necessary controls the bit rate of the encoded data, which is supplied from the LFR encoder section 111, by using the LFR target bit rate, which is determined by the bit rate determining section 101, to thereby create LFR encoded data. The LFR rate controlling section 121 outputs the created LFR encoded data to the outside of the image encoding apparatus 100. Alternatively, the LFR rate controlling section 121 supplies the created LFR encoded data to the storage section 106, and the storage section 106 stores the LFR encoded data.

The HFR rate controlling section 122 as necessary controls the bit rate of the encoded data, which is supplied from the LFR encoder section 111, by using the HFR target bit rate, which is determined by the bit rate determining section 101, to thereby create HFR encoded data (LFR). The HFR rate controlling section 122 supplies the created HFR encoded data (LFR) to the code stream integrating section 105.

The code stream integrating section 105 integrates the HFR encoded data (HFR-LFR), which is supplied from the HFR encoder section 112, and the HFR encoded data (LFR), which is supplied from the HFR rate controlling section 122, to thereby create one code stream. The HFR encoded data (HFR-LFR) and the HFR encoded data (LFR) are created by encoding the same HFR image data. The HFR encoded data (HFR-LFR) is created by encoding image data of some frames. The HFR encoded data (LFR) is created by encoding image data of the other frames. That is, the pieces of encoded data are integrated in an appropriate order, to thereby create one code stream. As a result, all the frames of HFR image data are encoded, to thereby obtain encoded data (HFR encoded data).

Note that the HFR encoder section 112 controls the bit rate of the HFR encoded data (HFR-LFR), which is to be integrated, by using the HFR target bit rate. Further, the HFR rate controlling section 122 controls the bit rate of the HFR encoded data (LFR), which is to be integrated, by using the HFR target bit rate. Because of this, there is no large difference between the bit rate of the HFR encoded data (HFR-LFR) and the bit rate of the HFR encoded data (LFR). The HFR encoded data (HFR-LFR) and the HFR encoded data (LFR) are integrated, whereby HFR encoded data is created. As a result, when reproducing an image of the thus created HFR encoded data, it is possible to reduce a feeling of strangeness in the eyesight of a viewer, which is due to a large difference of the bit amounts between frames.

The code stream integrating section 105 outputs the created code stream (HFR encoded data) to the outside of the image encoding apparatus 100. Alternatively, the code stream integrating section 105 supplies the created code stream (HFR encoded data) to the storage section 106, and the storage section 106 stores the code stream (HFR encoded data).

The storage section 106 is configured to store the LFR encoded data, which is supplied from the LFR rate controlling section 121, and the HFR encoded data, which is supplied from the code stream integrating section 105. The storage section 106 may store one of or both of the LFR encoded data and the HFR encoded data. For example, if LFR encoded data may be created based on HFR encoded data, only HFR encoded data may be stored in the storage section 106.

Further, if it is not necessary to store LFR encoded data and HFR encoded data, the storage section 106 may not be provided.

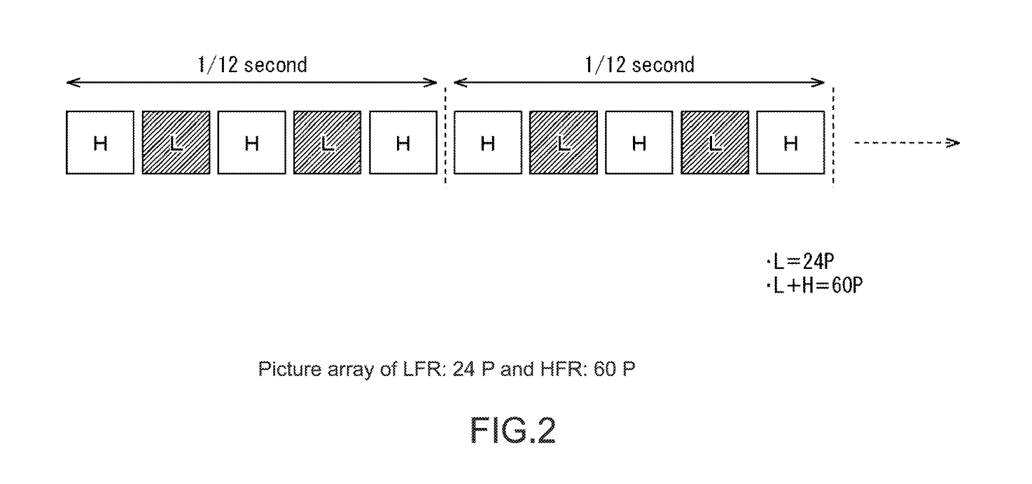

Next, how to select a picture will be described. FIG. 2 is a diagram for explaining an example of a relation of a picture array of LFR and HFR.

As shown in FIG. 2, the array of squares shows image data. Each square shows each frame. A square “H” shows a frame of HFR (High Frame Rate). A square “L” shows a frame of both HFR and LFR (Low Frame Rate). That is, HFR includes all the frames shown in FIG. 2. LFR includes some frames. Note that, in FIG. 2, each of “H” and “L” indicates that fact. FIG. 2 does not show an actual frame image.

Further, in the example of FIG. 2, the following is the specific LFR frame rate and the specific HFR frame rate. “24 P” indicates a progressive image of 24 frames per second. “60 P” indicates a progressive image of 60 frames per second.

Low Frame Rate=24 P

High Frame Rate=60 P

Further, two examples of LFR target bit rate (Bit_LFR) and two examples of HFR target bit rate (Bit_HFR) are shown in the following.

(Case-1):

Bit_HFR=500 Mbps/60 P=8.33 Mb/pic

Bit_LFR=250 Mbps/24 P=10.42 Mb/pic

That is, in this case, Bit_HFR<Bit_LFR is satisfied. That is, the target bit amount per picture of the LFR encoded data is larger than the target bit amount per picture of the HFR encoded data. Because of this, if the “L” picture (common frames) of FIG. 2 is encoded by using the LFR target bit rate, the bit rate of the HFR encoded data may be larger than 500 Mbps. In view of this, in this case, it is necessary to decrease the bit rate of the common frame to 8.33 Mbps, similar to the other frames.

(Case-2):

Bit_HFR=500 Mbps/60 P=8.33 Mb/pic

Bit_LFR=150 Mbps/24 P=6.25 Mb/pic

That is, in this case, Bit_HFR>Bit_LFR is satisfied. That is, the target bit amount per picture of the LFR encoded data is smaller than the target bit amount per picture of the HFR encoded data. Because of this, if the “L” picture (common frames) of FIG. 2 is encoded by using the LFR target bit rate, the bit rate of the HFR encoded data may be smaller than 500 Mbps. In view of this, in this case, it is necessary to increase the bit rate of the common frame to 8.33 Mbps, similar to the other frames.

A specific example of a rate controlling method will be described later. Now, the encoder section 103 (LFR encoder section 111 and HFR encoder section 112) of FIG. 1 will be described.

[1-4 Encoder Section]

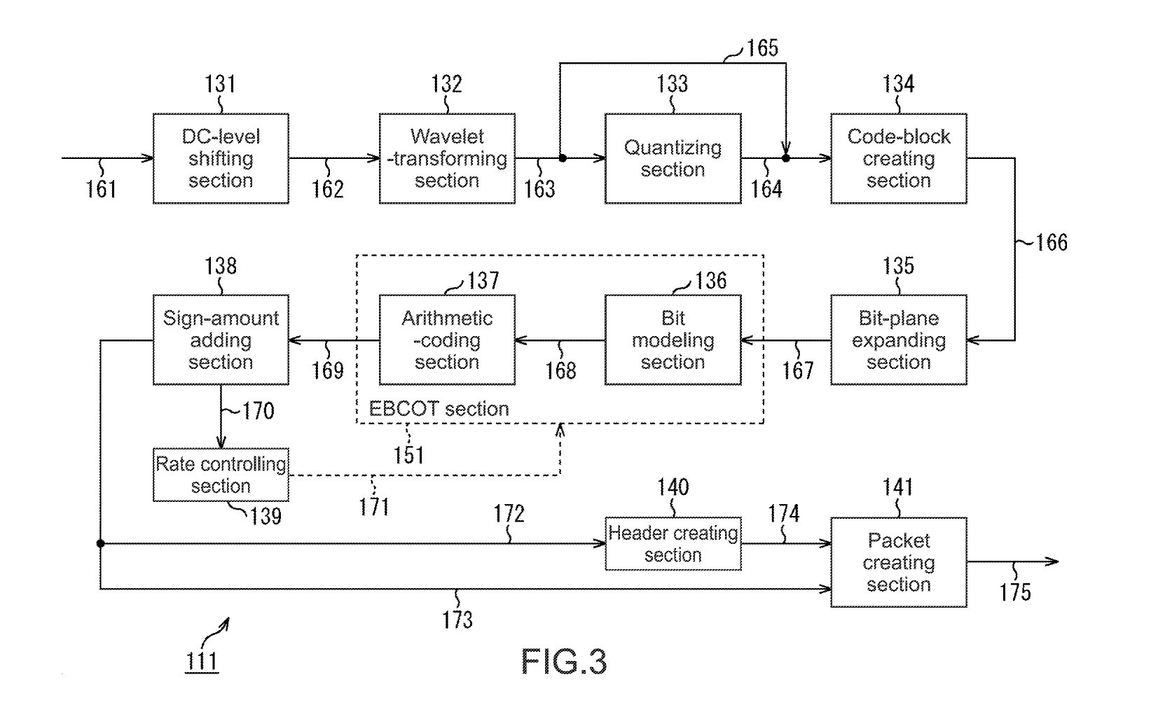

FIG. 3 is a diagram showing a main configuration example of the LFR encoder section 111. Note that the HFR encoder section 112 encodes frames, which are different from frames encoded by the LFR encoder section 111. The target bit rate of frames, which are encoded by the HFR encoder section 112, is different from target bit rate of frames, which are encoded by the LFR encoder section 111. The HFR encoder section 112 basically has a configuration similar to the configuration of the LFR encoder section 111. Process executed by the HFR encoder section 112 is similar to process executed by the LFR encoder section 111. In view of this, hereinafter, the configuration of the LFR encoder section 111 will be described. What is described about the LFR encoder section 111 will be applied to the HFR encoder section 112. Description of the HFR encoder section 112 will be omitted.

The LFR encoder section 111 encodes image data to thereby create a code stream, which has a progression structure similar to the progression structure of JPEG 2000 system. Alternatively, the LFR encoder section 111 may encode an image by using JPEG 2000 system. As shown in FIG. 3, the LFR encoder section 111 includes a DC-level shifting section 131, a wavelet-transforming section 132, a quantizing section 133, a code-block creating section 134, and a bit-plane expanding section 135.

The DC-level shifting section 131 shifts the level of the DC component of the HFR image data, which is input in the LFR encoder section 111 (arrow 161). Because of this, the wavelet-transform (latter stage) may be effectively performed. For example, an RGB signal has a positive value (unsigned integer). In view of this, the DC-level shifting section 131 utilizes that fact, and halves the dynamic range of the original signal to thereby shift the level. As a result, compression efficiency may be improved. In view of this, if the original signal is a signal having an integer value with a sign (both positive and negative), the level shifting is not performed. Examples of an integer value with a sign include color difference data Cb and color difference data Cr of an YCbCr signal.

The wavelet-transforming section 132 is a filter bank, which generally includes a lowpass filter and a highpass filter. Further, a digital filter generally has impulse response (filter coefficient) of a plurality of tap lengths. So the wavelet-transforming section 132 has a buffer. The buffer previously stores an input image to be filtered.

The wavelet-transforming section 132 obtains image data, which is output from the DC-level shifting section 131 (arrow 162). Specifically, the wavelet-transforming section 132 obtains the image data of a data volume necessary to perform filtering at the very least, or more. Then, the wavelet-transforming section 132 filters image data after DC-level shifting, by using a predetermined wavelet-transforming filter, to thereby create a wavelet coefficient. Note that the wavelet-transforming section 132 filters image data in the vertical direction and in the horizontal direction of the image, to thereby separate the image data into low-frequency components and high-frequency components.

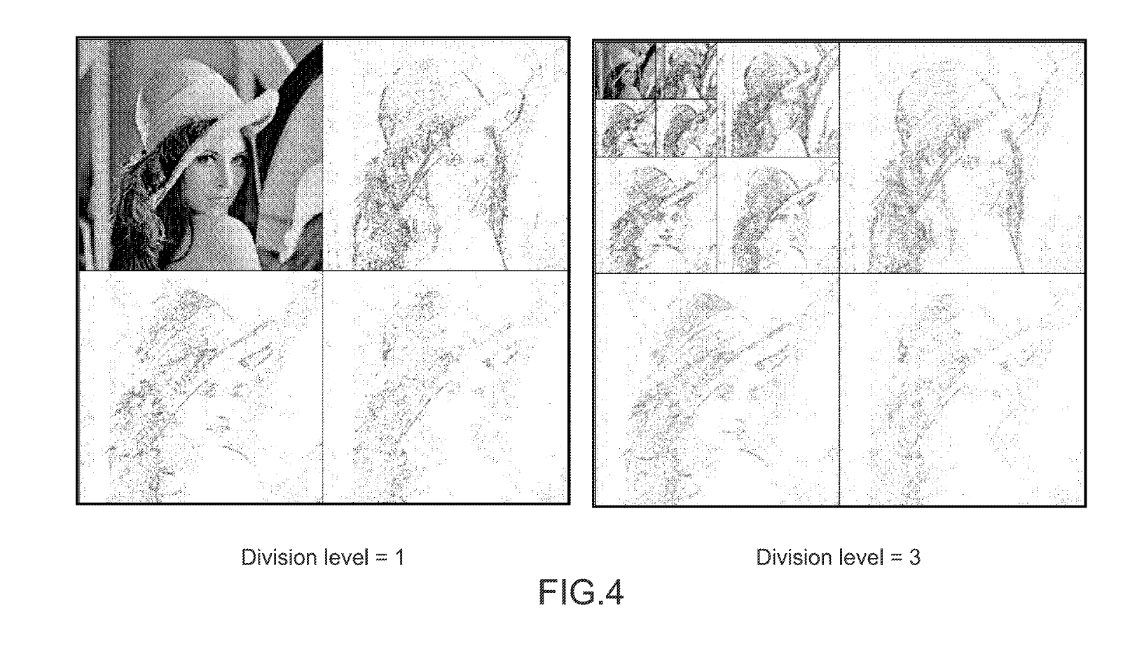

Then, the wavelet-transforming section 132 recursively repeats the filtering process by a predetermined number of times with respect to a subband, which is divided as a low-frequency component both in the vertical direction and the horizontal direction. This is because, for example, as shown in FIG. 4, low-frequency components include most image energy.

FIG. 4 is a diagram showing a configuration example of subband. As shown in FIG. 4, low-frequency components include most image energy both under the state where the division level number is one and under the state where the division level number is three.

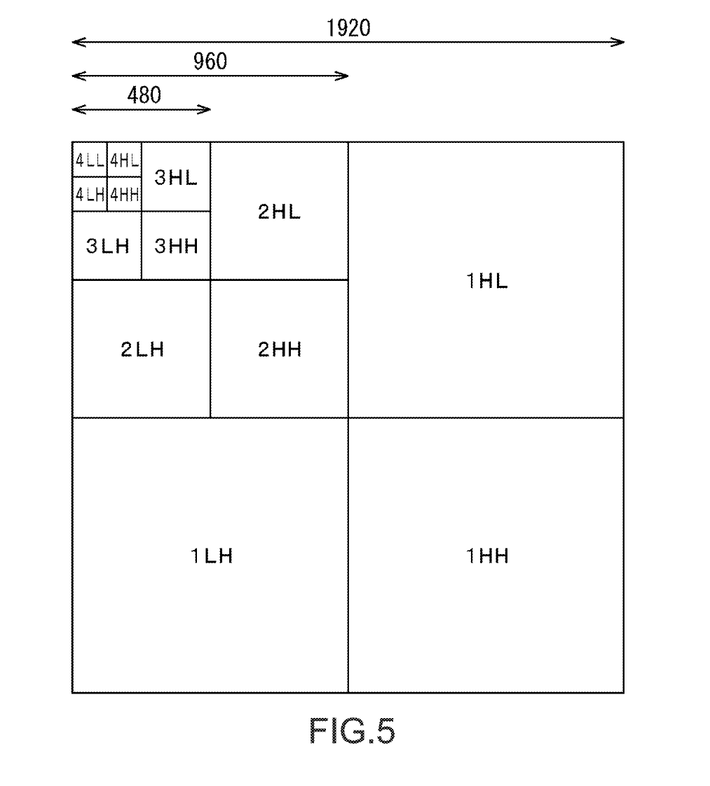

FIG. 5 is a diagram showing a configuration example of subband created by wavelet-transforming process under the state where the division level number is four.

In this case, first, the wavelet-transforming section 132 filters the entire image, to thereby create subbands 1LL (not shown), 1HL, 1LH, and 1HH. Next, the wavelet-transforming section 132 filters the created subband 1LL again, to thereby create subbands 2LL (not shown), 2HL, 2LH, and 2HH. Further, the wavelet-transforming section 132 filters the created subband 2LL again, to thereby create subbands 3LL, 3HL, 3LH, and 3HH. Further, the wavelet-transforming section 132 filters the created subband 3LL again, to thereby create subbands 4LL, 4HL, 4LH, and 4HH.

As described above, the analysis-filtering is performed until the division level number reaches four. As a result, thirteen subbands are created. As shown in FIG. 5, a subband has half the size in the vertical direction and in the horizontal direction of a lower subband by one division level.

That is, for example, baseband image data of an image having 1920 pixels in the horizontal direction is analysis-filtered once. As a result, four subbands (1LL, 1HL, 1LH, 1HH) are created. Each created subband has 960 pixels in the horizontal direction. Further, the subband 1LL is analysis-filtered once. As a result, four subbands (2LL, 2HL, 2LH, 2HH) are created. Each created subband has 480 pixels in the horizontal direction. Further, the subband 2LL is analysis-filtered once. As a result, four subbands (3LL, 3HL, 3LH, 3HH) are created. Each created subband has 240 pixels in the horizontal direction. Further, the subband 3LL is analysis-filtered once. As a result, four subbands (4LL, 4HL, 4LH, 4HH) are created. Each created subband has 120 pixels in the horizontal direction.

Note that the division level number of wavelet-transform is arbitrarily set.

The wavelet-transforming section 132 supplies wavelet coefficients, which are obtained by filtering, to the quantizing section 133 for each subband (arrow 163). The quantizing section 133 quantizes the supplied wavelet coefficient. An arbitrary quantizing method may be employed, and scalar quantization is used in general. According to scalar quantization, the wavelet coefficient is divided by a quantization step size. The quantizing section 133 obtains a quantization coefficient by quantization. The quantizing section 133 supplies the quantization coefficient to the code-block creating section 134 (arrow 164). Note that, in the latter stages, quantization coefficients are supplied instead of wavelet coefficients. The quantization coefficients are basically treated similar to the wavelet coefficients. In view of this, hereinafter, description of this point will be omitted unless it is necessary, and a quantization coefficient will simply be referred to as coefficient or coefficient data.

Note that, in a case where the LFR encoder section 111 encodes image data by means of a lossless encoding system, the process by the quantizing section 133 is omitted. The lossless encoding system is capable of completely decompressing original data by decoding process. Output from the wavelet-transforming section 132 is supplied to the code-block creating section 134 (arrow 165).

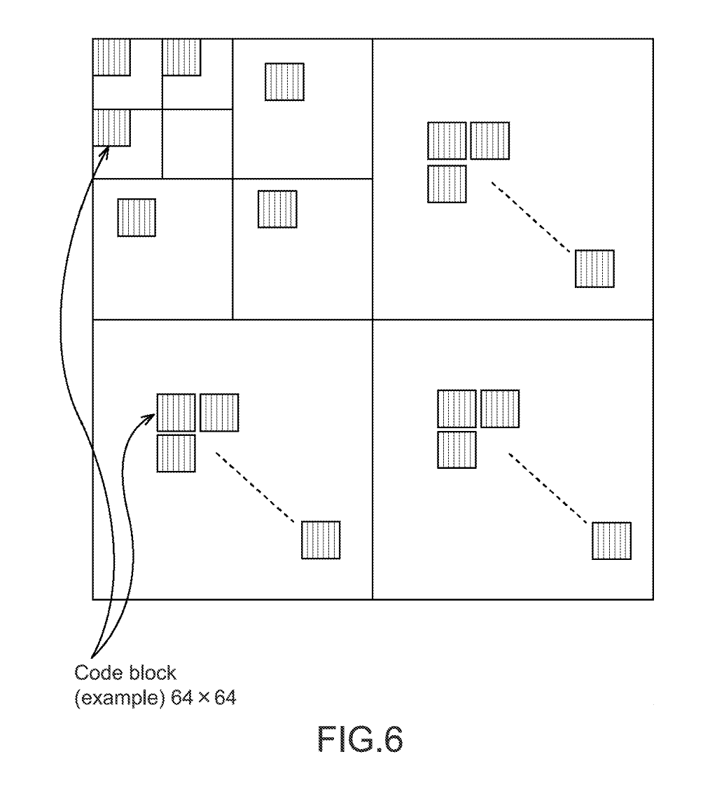

The code-block creating section 134 divides a wavelet coefficient into code blocks. The code block is a processing unit of entropy coding, and has a predetermined size. FIG. 6 shows positional relation of code blocks in each subband. Code blocks are created in all the divided subbands. For example, the size of a code block is about 64×64 pixels. Each processing section in the latter stage executes processing for each code block.

The code-block creating section 134 supplies the respective code blocks to the bit-plane expanding section 135 (arrow 166). The bit-plane expanding section 135 expands coefficient data into a bit plane for each digit position of bit.

A bit plane is obtained by dividing (slicing) a coefficient group by one bit, i.e., by each digit position. The coefficient group includes a predetermined number of wavelet coefficients. That is, a bit plane is a set of bits (coefficient bits) in each coefficient group, which have the same digit position.

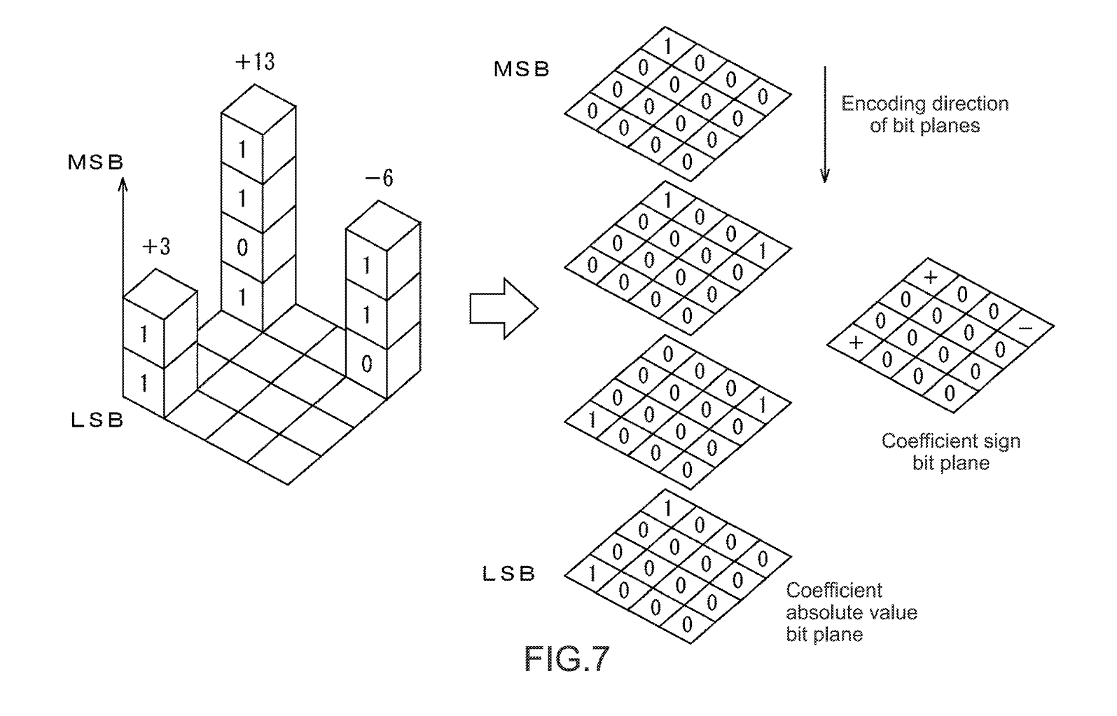

FIG. 7 shows its specific example. In FIG. 7, the left part shows 16 coefficients in total (4 in vertical direction×4 in horizontal direction). A coefficient, which has the largest absolute value out of the 16 coefficients, is 13. 13 is equal to 1101 in binary. The bit-plane expanding section 135 expands the coefficient group into four bit planes (absolute value bit plane) showing absolute values, and one bit plane (sign bit plane) showing signs. That is, the coefficient group of the left part of FIG. 7 is expanded into four absolute value bit planes and one sign bit plane, as shown in the right part of FIG. 7. Here, each of all the elements in the absolute value bit plane has the value 0 or 1. Further, each element in the sign bit plane shows the value showing that the coefficient value is positive, the value showing that the coefficient value is 0, or the value showing that the coefficient value is negative.

The LFR encoder section 111 further includes a bit modeling section 136, an arithmetic-coding section 137, a sign-amount adding section 138, a rate controlling section 139, a header creating section 140, and a packet creating section 141.

The bit-plane expanding section 135 supplies the expanded bit planes to the bit modeling section 136 (arrow 167).

The bit modeling section 136 and the arithmetic-coding section 137 function as an EBCOT (Embedded Coding with Optimized Truncation) section 151. The EBCOT section 151 performs entropy coding called EBCOT with respect to input coefficient data. EBCOT is specified by JPEG 2000 standard. According to EBCOT, a statistic of a coefficient in a block is measured for block having a predetermined size, and encoding is performed at the same time.

The bit modeling section 136 performs bit modeling with respect to coefficient data according to the procedure determined in JPEG 2000 standard. The bit modeling section 136 supplies information such as control information, symbols, and contexts, to the arithmetic-coding section 137 (arrow 168). The arithmetic-coding section 137 arithmetic-codes a bit plane of a coefficient.

The size of a code block in the vertical and horizontal directions is expressed by power of two (4 to 256). Examples of generally-used size include 32×32, 64×64, 128×32, and the like. A signed binary number of n bits expresses a coefficient value. Each of 0th bit to (n−2)th bit expresses a bit of each of LSB to MSB. The other 1 bit expresses a sign. Encoding of a sign block is executed by using the following three coding passes in the order from the bit plane at the MSB side.

(1) Significant Propagation Pass

(2) Magnitude Refinement Pass

(3) Cleanup Pass

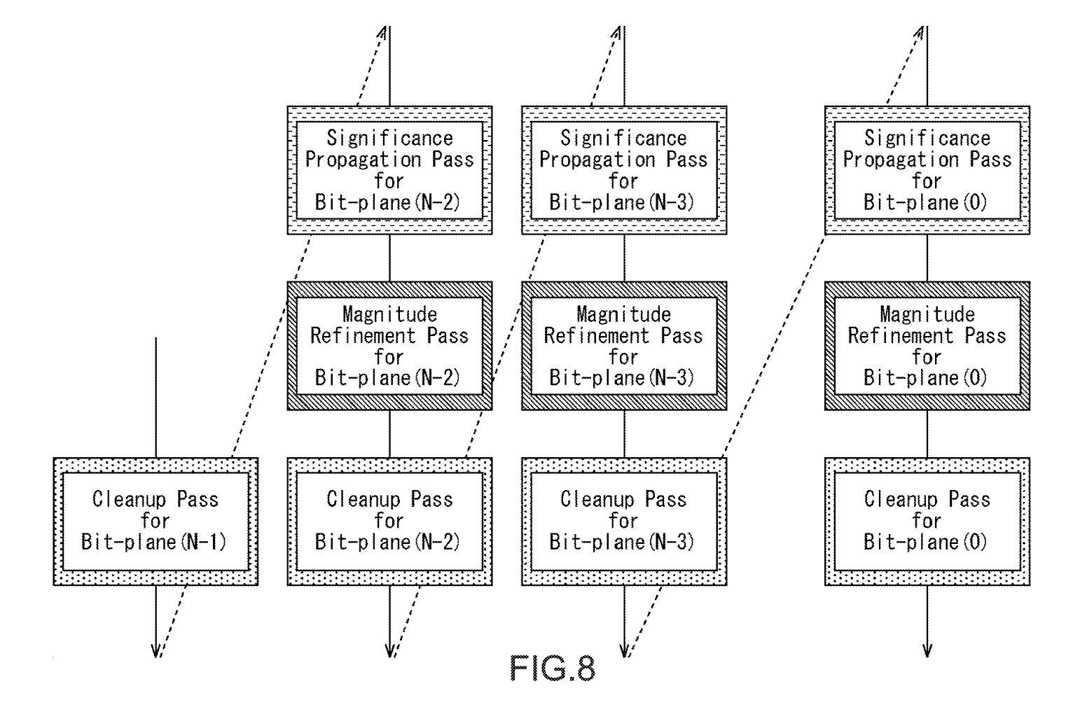

FIG. 8 shows the order of using the three coding passes. First, Bit-plane (n−1) (MSB) is encoded by using Cleanup Pass. Next, encoding of each bit plane is performed by using the three coding passes, i.e., Significant Propagation Pass, Magnitude Refinement Pass, and Cleanup Pass, in this order, to the LSB side.

Note that, in fact, the order of a bit plane from the MSB side, which has 1 for the first time, is written in a header. Continuous bit planes (referred to as zero bit planes) from the MSB side, all of which have 0, are not encoded. The three coding passes are repeatedly used in this order, to thereby encode image data. Encoding is stopped at an arbitrary bit plane and at an arbitrary coding pass. As a result, a tradeoff between a sign amount and an image quality is established (rate is controlled).

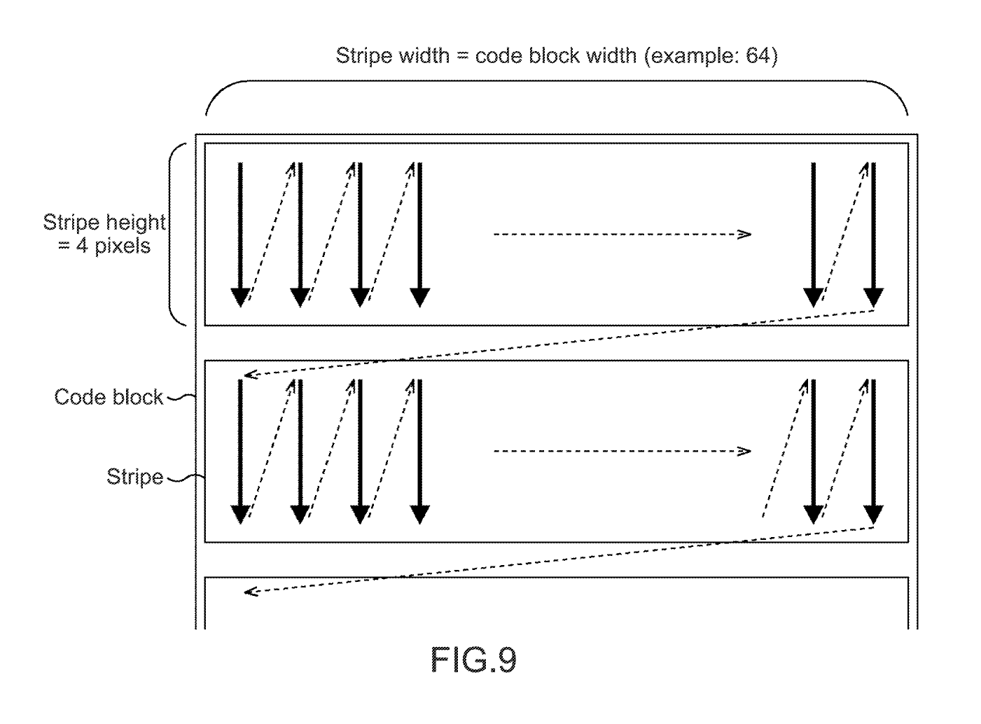

Next, with reference to FIG. 9, coefficient scanning will be described. Code blocks are divided into stripes. The height of a stripe is four coefficients. The width of a stripe is equal to the width of a code block. The scanning order means the order of tracking all the coefficients in one code block. The scanning order includes the order from upper stripes to lower stripes in a code block, the order from left lines to right lines in a stripe, and the order from up to bottom in a line. According to each coding pass, all the coefficients in a code block are processed in this scanning order.

Hereinafter, the three coding passes will be described. The following are written in JPEG-2000 written standards (reference: ISO/IEC 15444-1, Information technology-JPEG 2000, Part 1: Core coding system).

(1) Significance Propagation Pass (SP Pass):

According to Significance Propagation Pass for encoding a certain bit plane, a bit plane value of a non-significant coefficient is arithmetic-coded. Here, at least one coefficient in the vicinity of 8 is significant. If the encoded bit plane value is 1, next, MQ-coding is performed. MQ-coding shows if the sign is positive (+) or negative (−).

Here, the term “significance” specific to JPEG 2000 will be described. Significance is the state of an encoder with respect to each coefficient. The initial value of significance is 0, which shows non-significance. When 1 is encoded with the coefficient, the significance changes to 1, which shows significance. After that, the significance is always 1. In view of this, the significance functions as a flag showing if information having a significant digit is encoded or not. When the significance of a certain bit plane is significant, all the bit planes after that are significant.

(2) Magnitude Refinement Pass (MR Pass):

Magnitude Refinement Pass for encoding a bit plane is Significance Propagation Pass for encoding a bit plane. According to Magnitude Refinement Pass, a bit plane value of a not-encoded significant coefficient value is MQ-coded.

(3) Cleanup Pass (CU Pass):

Cleanup Pass for encoding a bit plane is Significance Propagation Pass for encoding a bit plane. According to Cleanup Pass, a bit plane value of a not-encoded non-significant coefficient value is MQ-coded. If the encoded bit plane value is 1, next, MQ-coding is performed. MQ-coding shows if the sign is positive (+) or negative (−) (Sign information).

Note that, in MQ-coding of each of the above-mentioned three coding passes, one of ZC (Zero Coding), RLC (Run-Length Coding), SC (Sign Coding), and MR (Magnitude Refinement) is used depending on cases. Here, an arithmetic sign called MQ-coding is used. MQ-coding is a learning binary arithmetic sign, which is determined in JBIG 2 (reference: ISO/IEC FDIS 14492, “Lossy/Lossless Coding of Bi-level Images”, March 2000).

With reference to FIG. 3 again, the arithmetic-coding section 137 supplies the created code stream to the sign-amount adding section 138 (arrow 169). The sign-amount adding section 138 counts the sign amounts of the code stream, and accumulates them.

Then, the sign-amount adding section 138 supplies the code stream to a header creating section 140 (arrow 172) and to the packet creating section 141 (arrow 173). In addition, the sign-amount adding section 138 supplies the sign-amount accumulated value to the rate controlling section 139 (arrow 170). The rate controlling section 139 controls the EBCOT section 151 based on the supplied sign-amount accumulated value (arrow 171). At the time when the accumulated value reaches the target sign amount, encoding is finished. That is, the rate controlling section 139 controls the created sign amount (controls rate of code stream).

The packet creating section 141 creates packets including the supplied code streams. The header creating section 140 creates header information of the packets. The header creating section 140 supplies the header information to the packet creating section 141 (arrow 174). The packet creating section 141 creates packets by using the header information.

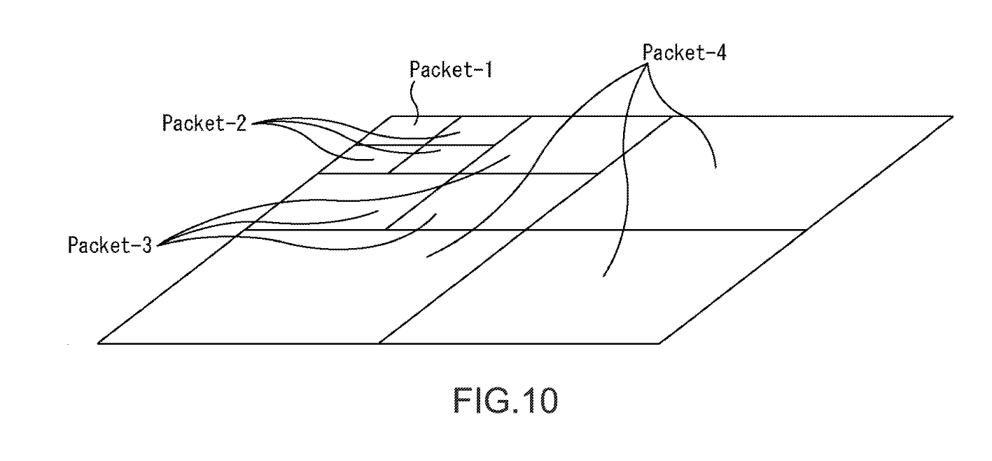

FIG. 10 conceptually shows the packet. In the example of FIG. 10, wavelet-transform is performed three times. FIG. 10 shows that four kinds of packets, i.e., Packet-1 of the lowest frequency to Packet-4 of the highest frequency, are created as the result. That is, encoded code streams of all the sign blocks in the subbands in each packet are packed for each packet.

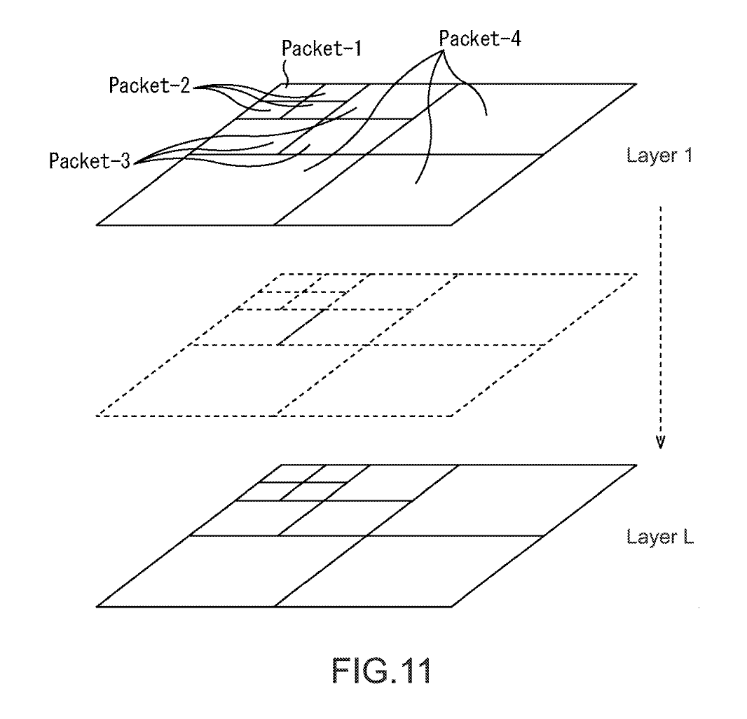

Further, FIG. 11 shows a case where a coding pass is divided into L layers, i.e., layer 1 to layer L. In a certain code block, the beginning coding pass of the layer n is immediately after the rearmost coding pass of the layer (n−1). That is, as the number of layers increases, the sign amount of a code stream increases. That is, the image quality of a decoded image is increased (resolution does not change).

Because of this, when decoding, layers to be decoded, i.e., layer 1 to a certain layer, are controlled. As a result, the image quality of a decoded image may be controlled. Hereinafter, when not described specifically, “image quality” means a visual quality of a decoded image. The visual quality of a decoded image depends on the layer (i.e., information amount of each pixel).

Note that the encoder (image encoding apparatus 100) may set a code block and its coding pass, at which a layer is divided. Code streams of all the code blocks in the subbands in the above-mentioned packet are packed for each packet.

The created packet is output to the outside (arrow 175).

As described above, the encoder section 103 encodes image data by means of JPEG 2000 system. The encoder section 103 creates a code stream having JPEG 2000 progression function about resolution, layers, and the like.

Encoding by means of JPEG 2000 is characterized by a bit plane, and by a subband created by means of wavelet-transform. The progression may be defined by them.

Progression is the order of code words in the same category. For example, code words of different layers in the same resolution level are collected. As a result, an image having the same image size and a different image quality may be created. To the contrary, code words of the same layer in different resolution levels are collected. As a result, an image having the same image quality and a different image size may be created. That is, progression is a data structure for realizing expandability of a decoded image.

According to JPEG 2000, as described above, a part of data may be decoded from a code stream about a predetermined element. As a result, it is possible to easily obtain various decoded images from one code stream. That is, if a code stream has such a progression structure, the code stream may be used for various purposes. As a result, user-friendliness of a code stream is improved.

For example, the following cases may be easily realized by selecting progression elements such as a layer to be decoded and a subband. That is, a decoded image having a higher resolution and a higher bit rate is provided to a large-screen, expressive, and high-performance liquid crystal display based on one code stream. A decoded image having a lower resolution and lower bit rate is provided to a mobile phone or the like, which has a small screen and a lower image processing capacity.

Note that such a progression structure may be used not only for decoding process, but also for transforming (transcoding) process. According to the transforming (transcoding) process, the image size, the image quality, and the like of a decoded image are changed. That is, similar to the above-mentioned decoding process, only by selecting progression elements such as a layer and a subband, it is possible to easily create (i.e., transcode) a code stream, with which an image size and an image quality of a decoded image are different.

JPEG 2000 has four progression elements, i.e., resolution level, layer, position, and component.

As shown in FIG. 4, the resolution level is a level created by means of wavelet-transform. That is, the resolution level defines the image size of a decoded image. As shown in FIG. 11, the layer is an element giving an influence to an image quality by the level of the bit plane direction. Further, the component is defined when there are different components such as YCbCr, for example (YCbCr or RGB has three components). Finally, the position relates to tiling, which is one feature of JPEG 2000. The position defines the number and positions of tiles, in a case where a screen is divided into a plurality of square blocks and is encoded/decoded.

As described above, if there are a plurality of progression elements, a layer structure is created for each element. JPEG 2000 Part-1 has five layer structures each using the above-mentioned element, i.e., LRCP (Layer Resolution-level Component Position Progression), RLCP (Resolution-level Layer Component Position Progression), RPCL (Resolution-level Position Component Layer), PCRL (Position Component Resolution-level Layer), and CPRL (Component Position Resolution-level Layer).

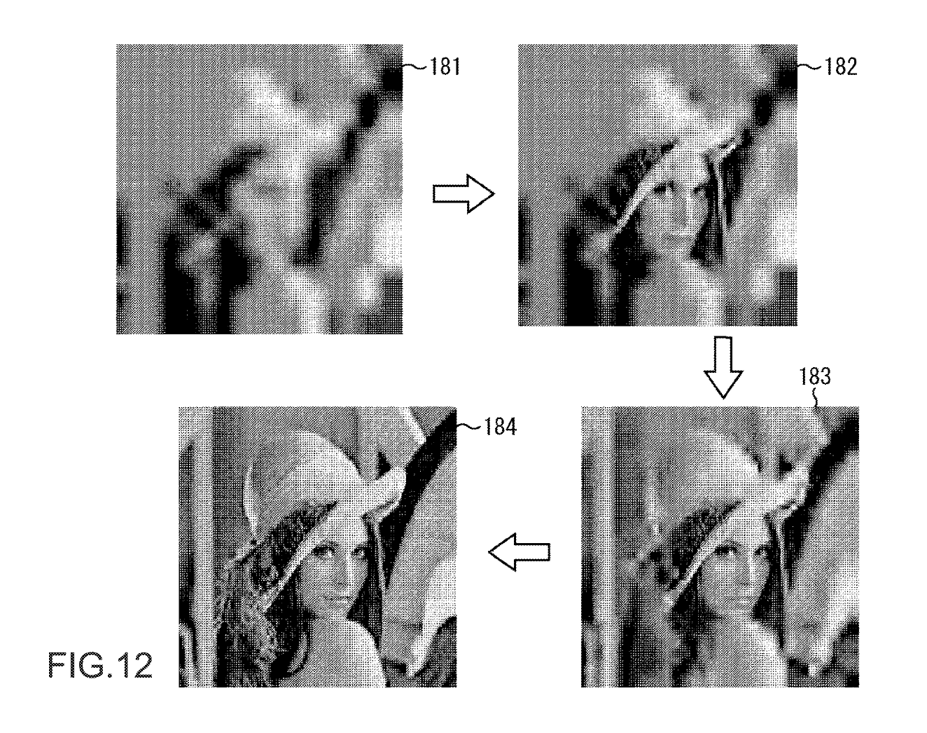

FIG. 12 shows that JPEG 2000 code words are arrayed in the LRCP order to thereby obtain encoded code streams, and that the encoded code streams are decoded in this order to thereby create decoded images. According to the progression structure, packets are arrayed in the following order. That is, the code words are arrayed as follows. The highest layer is a layer (number of all layers=L). The second highest layer is a resolution level (highest resolution level is N(max)). The third highest layer is a component (total number of components is Csiz). The lowest layer is a position. Note that the position (P) is not described below.

```
    for each l = 0, ..., L−1
    for each r = 0, ..., N(max)
    for each i = 0, ..., Csiz−1
    {packet for component(i), resolution-level(r),
layer(l)
    }
```

In this case, because the highest layer shows a layer, decoded images are displayed such that the image quality is gradually improved in the order of an image 181, an image 182, an image 183, and an image 184 of FIG. 12.

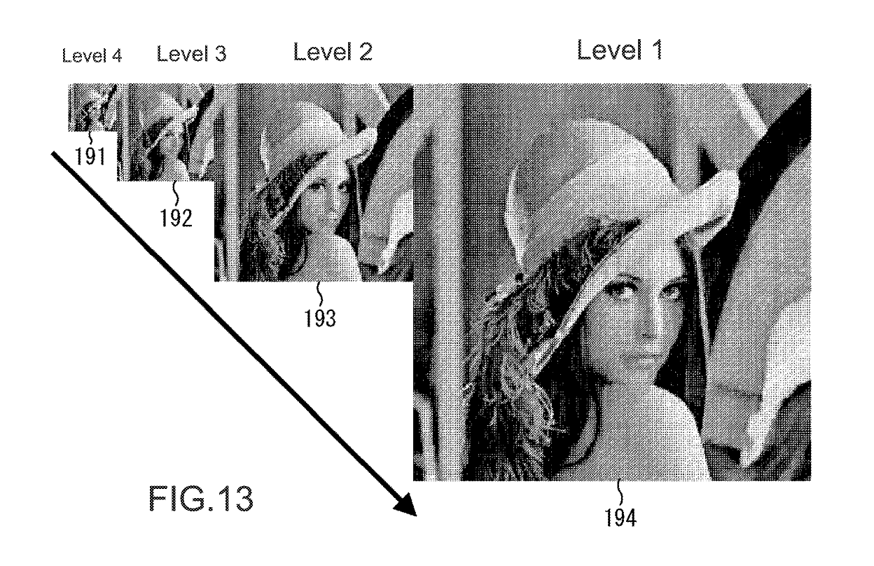

FIG. 13 shows that JPEG 2000 code words are arrayed in the order of RLCP to thereby obtain an encoded code stream, and the encoded code stream is decoded in the order of RLCP to thereby create decoded images. In this progression structure, packets are arrayed in the following order. That is, code words are arrayed in the following manner. The highest layer is a resolution level. The second highest layer is a layer. The third highest layer is a component. The lowest layer is a position. Note that the position (P) is not described below.

```
    for each r = 0, ..., N(max)
    for each l = 0, ..., L−1
    for each i = 0, ..., Csiz−1
    {packet for component(i), resolution-level(r),
layer(l)
    }
```

In this case, because the highest layer shows a resolution level, decoded images are displayed such that the image size (resolution) is gradually increased in the order of an image 191, an image 192, an image 193, and an image 194 of FIG. 13.

In this manner, the order of decoding process of a code stream is different depending on the layer structure of each progression element. In addition, how decoded images are displayed is changed. Similarly, decoding process is executed in the order depending on the layer structure of each of RPCL, PCRL, and CPRL.

[1-5 Rate Control]

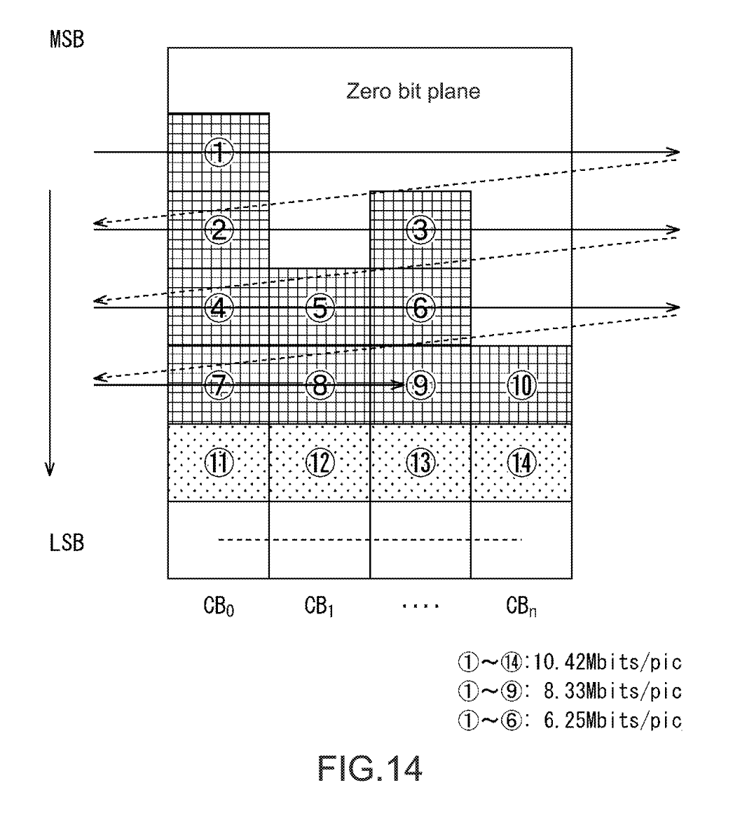

Next, rate control will be described. FIG. 14 is a diagram for explaining an example of how to control rates. First, the above mentioned (Case-1) (Bit_HFR<Bit_LFR) will be described. As described above, Bit_HFR and Bit_LFR are as follows in this case.

Bit_HFR=500 Mbps/60 P=8.33 Mbits/pic

Bit_LFR=250 Mbps/24 P=10.42 Mbits/pic

In this case, as shown in FIG. 2, let's say 60 Pictures for one second include 24 Pictures of L as they are. In this case, as described above, the HFR bit rate exceeds 500 Mbps. In view of this, it is necessary to reduce 24 Pictures of L to 8.33 Mbits/pic.

In FIG. 14, each of CB0, CB1, . . . CBn is the number of code block. If JPEG 2000 EBCOT encoding is used, the sign amount may be controlled for each bit plane from the upper MSB to the lower LSB.

For example, let's say the created sign amount of bit planes (1) to (14) (circled numbers in FIG. 14. The same applies to the following.) of the highest bit plane is the above-mentioned Bit_LFR. Further, let's say the created sign amount of bit planes (1) to (9) is the above-mentioned Bit_HFR.

In this case, the rate controlling section 104 rounds down the created sign amounts of the bit planes (10) to (14). As a result, the bit rate may be reduced from Bit_LFR to Bit_HFR. In this manner, the rate controlling section 104 is capable of transforming an encoded code stream, which is encoded at a higher bit rate, by means of an operation of the code stream level. That is, it is not necessary for the rate controlling section 104 to decode and re-encode the encoded code stream.

Next, (Case-2) will be described. As described above, Bit_HFR and Bit_LFR are as follows in this case.

Bit_HFR=500 Mbps/60 P=8.33 Mb/pic

Bit_LFR=150 Mbps/24 P=6.25 Mb/pic

In this case, Bit_LFR<Bit_HFR is satisfied. Let's say the created sign amount of bit planes (1) to (6) of FIG. 14 is Bit_LFR. Then, the HFR bit rate does not reach 500 Mbps. This is because the created sign amount of pictures of 24 P in the moving image of 60 P is small. In view of this, when encoding L pictures, the created sign amount may be increased to 8.33 Mbps (value same as Bit_HFR) of the bit planes (1) to (9). As a result, the 60 P bit rate may be maintained.

As described above, according to the present technology, a moving image signal is encoded while, in parallel, a bit rate for low frame rate and a bit rate for high frame rate are satisfied. As a result, an encoded code stream for a low frame rate and an encoded code stream for a high frame rate are created. As a result, to extract a part of a code stream for a high frame rate means to extract a code stream for a low frame rate.

As a result, it is not necessary to separately store/hold a code stream of a low frame rate and a code stream of a high frame rate, not as is conventionally done. Because of this, the capacity of a hard disk, a memory, and the like is reduced, which is effective. As a result, costs of hardware apparatuses are reduced, which is effective.

That is, the image encoding apparatus 100 is capable of creating encoded data of a plurality of kinds of frame rates from one piece of moving image data easily.

Note that the case where image data is encoded and encoded data of two frame rates is created has been described above. Alternatively, the number of kinds of frame rates (encoded data) may be arbitrarily set. Three or more frame rates (encoded data) may be employed. For example, encoded data of three or more different frame rates may be created from one piece of image data.

[1-6 Processing Flow]

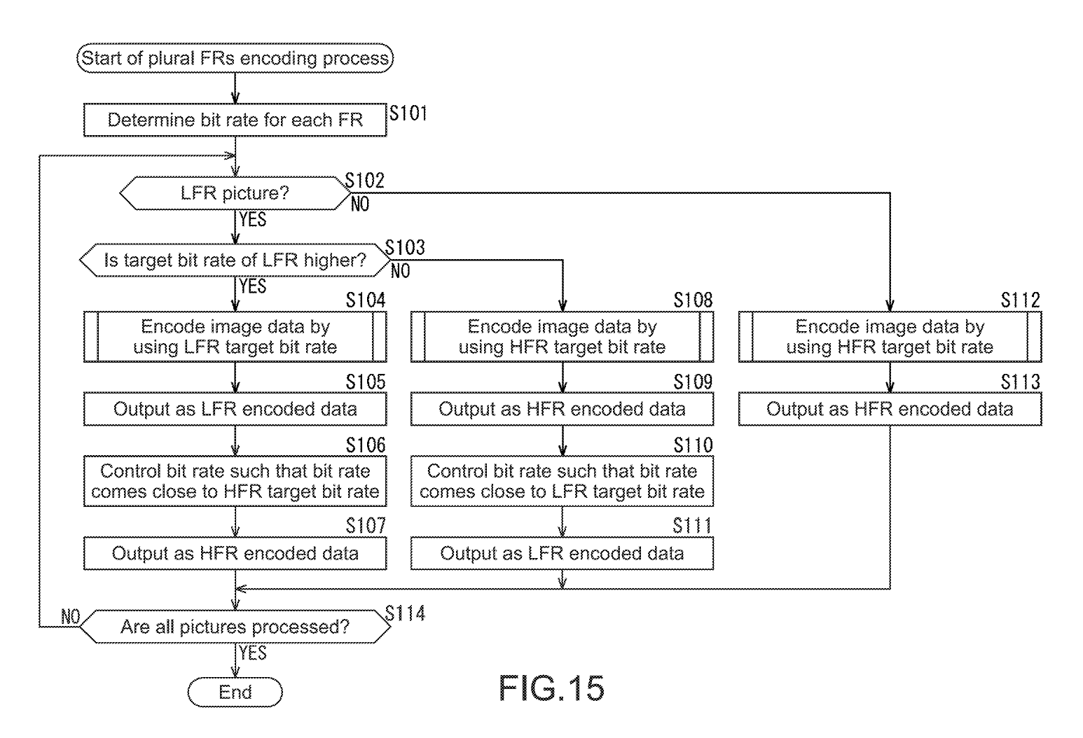

Next, processes executed by the image encoding apparatus 100 will be described. First, with reference to the flowchart of FIG. 15, an example of the flow of a plural FRs encoding process will be described.

When the plural FRs encoding process is started, the bit rate determining section 101 determines a target bit rate for each frame rate (FR) in Step S101.

In Step S102, the picture selecting section 102 determines if a processing target picture is an LFR picture or not. If it is determined that the processing target picture is an LFR picture, the process proceeds to Step S103.

In Step S103, the LFR encoder section 111 determines if the target bit rate of LFR is higher than the target bit rate of HFR. If it is determined that the target bit rate of LFR is higher than the target bit rate of HFR, the process proceeds to Step S104.

In Step S104, the LFR encoder section 111 encodes image data of the processing target picture by using the LFR target bit rate, which is determined in Step S101. The encoding process will be described later in detail.

When encoding is finished, in Step S105, the LFR rate controlling section 121 outputs encoded data of the processing target picture as LFR encoded data. The encoded data is obtained in the process of Step S104.

Further, in Step S106, the HFR rate controlling section 122 controls the bit rate of the encoded data of the processing target picture such that the bit rate comes close to the HFR target bit rate. The encoded data is obtained in the process of Step S104.

In Step S107, the code stream integrating section 105 outputs the encoded data of the processing target picture as HFR encoded data. The bit rate of the encoded data is controlled in the process of Step S106.

If the process of Step S107 is finished, the process proceeds to Step S114.

Further, if it is determined that the target bit rate of LFR is lower than the target bit rate of HFR in Step S103, the process proceeds to Step S108.

In Step S108, the LFR encoder section 111 encodes the image data of the processing target picture by using the HFR target bit rate, which is determined in Step S101. The encoding process will be described later in detail.

In Step S109, the code stream integrating section 105 outputs the encoded data of the processing target picture as HFR encoded data. The encoded data is obtained in the process of Step S108.

Further, in Step S110, the LFR rate controlling section 121 controls the bit rate of the encoded data such that the bit rate comes close to the LFR target bit rate. The encoded data is obtained in the process of Step S108.

In Step S111, the LFR rate controlling section 121 outputs the encoded data of the processing target picture as LFR encoded data. The bit rate of the encoded data is controlled in Step S110.

When the process of Step S111 is finished, the process proceeds to Step S114.

Further, if it is determined that the processing target picture is not an LFR picture in Step S102, the process proceeds to Step S112.

In Step S112, the HFR encoder section 112 encodes the image data of the processing target picture by using the HFR target bit rate, which is determined in Step S101. The encoding process will be described later in detail.

In Step S113, the code stream integrating section 105 outputs the encoded data of the processing target picture as HFR encoded data. The encoded data is obtained in the process of Step S112.

After the process of Step S113 is finished, the process proceeds to Step S114.

In Step S114, the picture selecting section 102 determines if all the pictures are processed or not. If it is determined that there is an unprocessed picture, the process returns to Step S102. That is, the process of Step S102 to the process of Step S114 are executed for each picture.

Note that, in a case where the target bit rate is changed for each picture, the loop process may include Step S101. In this case, if it is determined that there is an unprocessed picture in Step S114, the process returns to Step S101.

If it is determined that all the pictures are processed in Step S114, the plural FRs encoding process is finished.

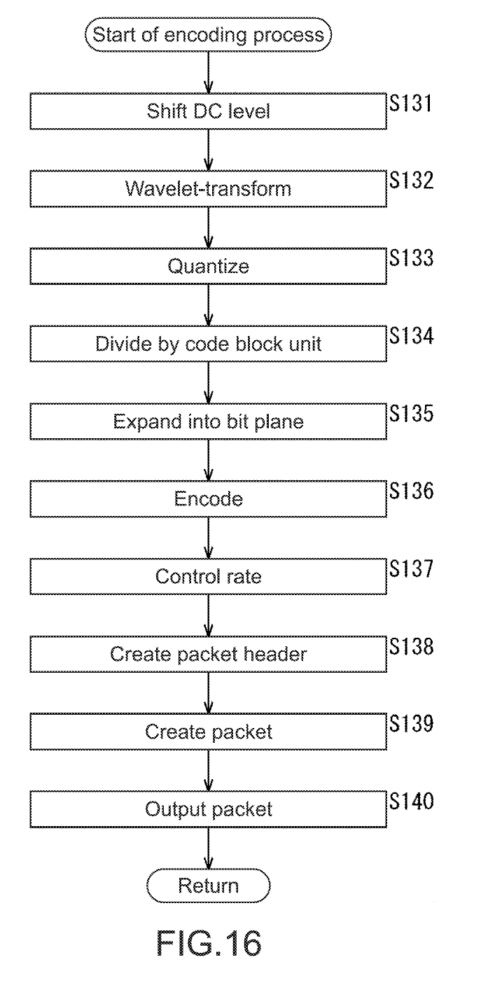

Next, with reference to the flowchart of FIG. 16, an example of the encoding process flow executed in Step S104, Step S108, and Step S112 of FIG. 15 will be described. Step S104, Step S108, and Step S112 basically execute the similar process except that the target bit rates are different.

When the encoding process is started, in Step S131, the DC-level shifting section 131 shifts the DC level of the image data. The image data is input from an input system. The DC-level shifting section 131 supports the input system. In Step S132, the wavelet-transforming section 132 wavelet-transforms the image data, of which DC level is shifted.

In Step S133, in the case of a lossy encoding system, the quantizing section 133 quantizes the wavelet coefficient created in Step S132. Note that, in the case of a lossless encoding system, the process is omitted.

In Step S134, the code-block creating section 134 divides the quantized coefficient by the code block unit. In Step S135, the bit-plane expanding section 135 expands the coefficient for each code block into a bit plane.

In Step S136, the EBCOT section 151 encodes the coefficient, which is expanded into a bit plane. In Step S137, the rate controlling section 139 uses the sign amount added by the sign-amount adding section 138, and the like. The rate controlling section 139 controls the rate of the created sign amount such that the rate comes close to the target bit rate, which is determined by the bit rate determining section 101.

In Step S138, the header creating section 140 creates a packet header. In Step S139, the packet creating section 141 creates packets. In Step S140, the encoder section 103 outputs the packets to the outside.

When the process of Step S140 is finished, the encoding process is finished. The process returns to Step S104, Step S108, or Step S112 of FIG. 15.

By executing the respective processes as described above, the image encoding apparatus 100 is capable of creating encoded data of a plurality of kinds of frame rates from one piece of moving image data easily.

### 2. Second Embodiment

[2-1 Image Encoding Apparatus]

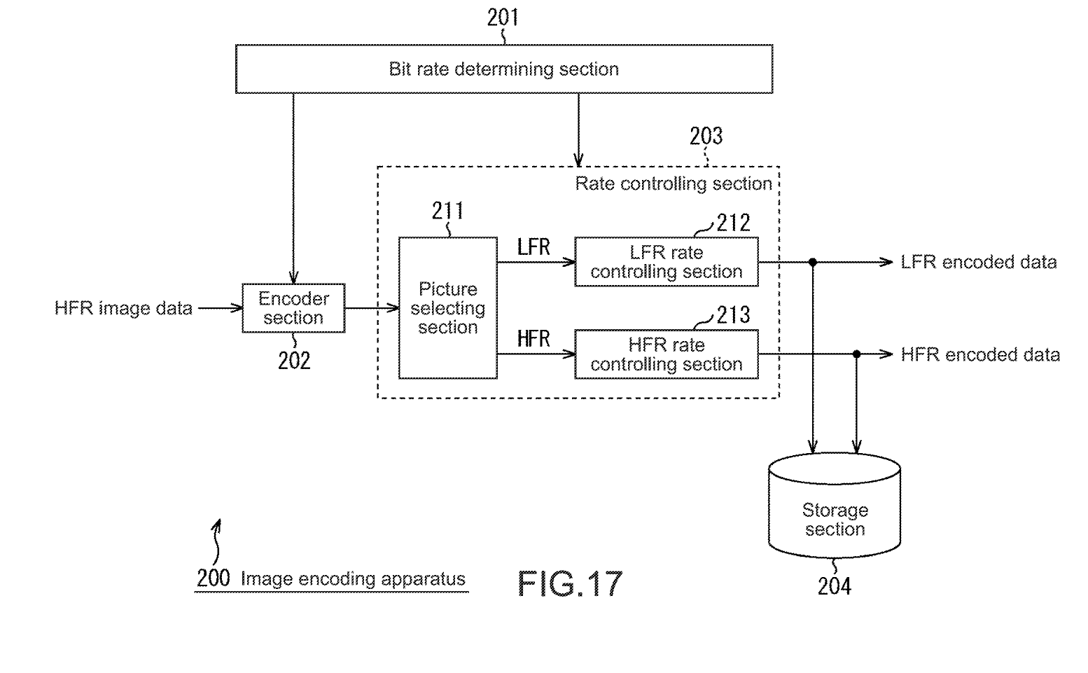

Note that a picture may be selected after encoding. FIG. 17 is a block diagram showing another configuration example of an image encoding apparatus.

An image encoding apparatus 200 of FIG. 17 is an image processing apparatus, to which the present technology is applied. The image encoding apparatus 200 is configured to create encoded data of a plurality of frame rates from one piece of image data, similar to the image encoding apparatus 100 of FIG. 1.

As shown in FIG. 17, the image encoding apparatus 200 includes a bit rate determining section 201, an encoder section 202, a rate controlling section 203, and a storage section 204.

Similar to the bit rate determining section 101 of FIG. 1, the bit rate determining section 201 determines the LFR target bit rate and HFR target bit rate. The bit rate determining section 201 supplies control information to the encoder section 202 and the rate controlling section 203. The control information shows the determined target bit rates. The bit rate determining section 201 controls behaviors of the encoder section 202 and the rate controlling section 203.

The encoder section 202 encodes the image data (HFR image data) of high frame rate, which is input in the image encoding apparatus 200, by means of, for example, JPEG 2000 system. The encoder section 202 encodes image data by using a bit rate. Here, the bit rate is the higher bit rate of the LFR target bit rate and the HFR target bit rate, which are determined by the bit rate determining section 201. The encoder section 202 supplies the encoded data (HFR encoded data) of high frame rate, which is obtained by encoding, to the rate controlling section 203.

The rate controlling section 203 extracts data of some frames from the HFR encoded data, which is created by the encoder section 202, to thereby create encoded data (LFR encoded data) of low frame rate. The rate controlling section 203 transforms the bit rate of LFR encoded data and the bit rate of HFR encoded data by using the target bit rates, which are determined by the bit rate determining section 201. The rate controlling section 203 outputs the LFR encoded data, of which the bit rate is controlled, and the HFR encoded data, of which the bit rate is controlled, to the outside of the image encoding apparatus 200. Alternatively, the rate controlling section 203 supplies the LFR encoded data, of which the bit rate is controlled, and the HFR encoded data, of which the bit rate is controlled, to the storage section 204. The storage section 204 stores the LFR encoded data, of which the bit rate is controlled, and the HFR encoded data, of which the bit rate is controlled. Alternatively, the rate controlling section 203 may output one to the outside, and the storage section 204 may store the other.

As shown in FIG. 17, the rate controlling section 203 includes a picture selecting section 211, an LFR rate controlling section 212, and an HFR rate controlling section 213.

The picture selecting section 211 detects data of frames of LFR from the HFR encoded data, which is supplied from the encoder section 202. The picture selecting section 211 extracts the data. The picture selecting section 211 supplies the extracted data (data of some frames) to the LFR rate controlling section 212 as LFR encoded data.

Note that, at the same time, the picture selecting section 211 supplies the HFR encoded data (data of all frames), which is supplied from the encoder section 202, to the HFR rate controlling section 213.

The LFR rate controlling section 212 controls the bit rate of the LFR encoded data, which is supplied from the picture selecting section 211, such that the bit rate comes close to the LFR target bit rate, which is determined by the bit rate determining section 201. The LFR rate controlling section 212 outputs the LFR encoded data, of which bit rate is controlled, to the outside of the image encoding apparatus 200. Alternatively, the LFR rate controlling section 212 supplies the LFR encoded data, of which bit rate is controlled, to the storage section 204. The storage section 204 stores the LFR encoded data, of which bit rate is controlled.

Note that, if the encoder section 202 encodes image data by using the LFR target bit rate, the LFR rate controlling section 212 may be omitted. In this case, the LFR encoded data, which is output from the picture selecting section 211, is output to the outside of the image encoding apparatus 200. Alternatively, the LFR encoded data, which is output from the picture selecting section 211, is supplied to the storage section 204. The storage section 204 stores the LFR encoded data, which is output from the picture selecting section 211.

The HFR rate controlling section 213 controls the bit rate of the HFR encoded data, which is supplied from the picture selecting section 211, such that the bit rate of the HFR encoded data comes close to the HFR target bit rate, which is determined by the bit rate determining section 201. The HFR rate controlling section 213 outputs the HFR encoded data, of which bit rate is controlled, to the outside of the image encoding apparatus 200. Alternatively, the HFR rate controlling section 213 supplies HFR encoded data, of which bit rate is controlled, to the storage section 204. The storage section 204 stores HFR encoded data, of which bit rate is controlled.

Note that, if the encoder section 202 encodes image data by using HFR target bit rate, the HFR rate controlling section 213 may be omitted. In this case, the HFR encoded data, which is output from the picture selecting section 211, is output to the outside of the image encoding apparatus 200. Alternatively, the HFR encoded data, which is output from the picture selecting section 211, is supplied to the storage section 204. The storage section 204 stores the HFR encoded data, which is output from the picture selecting section 211.

The storage section 204 is similar to the storage section 106. The storage section 204 is configured to store the LFR encoded data, which is supplied from the LFR rate controlling section 212, and the HFR encoded data, which is supplied from the HFR rate controlling section 213. The storage section 204 may store one of or both of the LFR encoded data and the HFR encoded data. For example, if it is possible to create LFR encoded data based on HFR encoded data, the storage section 204 may only store HFR encoded data.

Further, if it is not necessary to store LFR encoded data or HFR encoded data, the storage section 204 may not be provided.

As described above, a picture is selected at a stage latter than the encoding process. As a result, similar to the image encoding apparatus 100, the image encoding apparatus 200 is capable of creating encoded data of a plurality of kinds of frame rates from one piece of moving image data easily.

Further, as shown in FIG. 17, the processing section of the image encoding apparatus 200 may be simpler than the processing section of the image encoding apparatus 100. Because of this, in a case of realizing the respective processing sections of the image encoding apparatus by using hardware, the circuit size may not be large, and the production cost may not be increased. Further, in a case of realizing the image encoding apparatus by using software, each process is easily executed. Further, the delay time due to encoding or rate control may not be increased.

[2-2 Processing Flow]

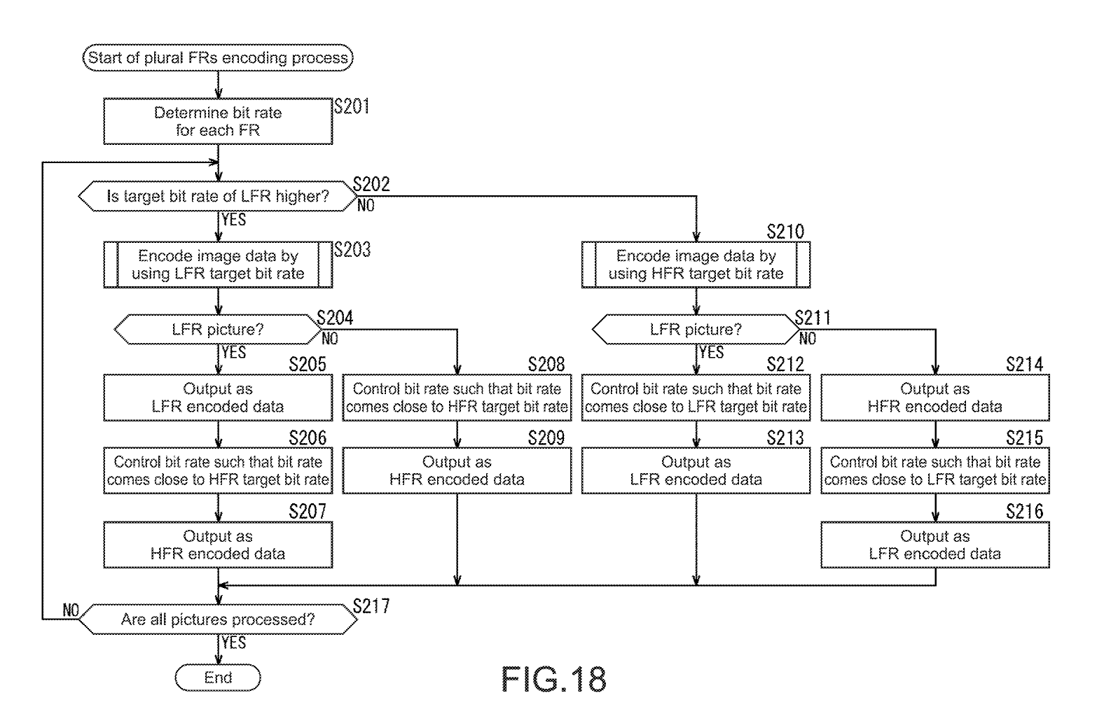

Next, the processing flow executed by the image encoding apparatus 200 will be described. With reference to the flowchart of FIG. 18, the flow of a plural FRs encoding process by the image encoding apparatus 200 will be described.

When the plural FRs encoding process is started, in Step S201, the bit rate determining section 201 determines a target bit rate for each frame rate (FR).

In Step S202, the encoder section 202 determines if the target bit rate of LFR is higher than the target bit rate of HFR. If it is determined that the target bit rate of LFR is higher than the target bit rate of HFR, the process proceeds to Step S203.

In Step S203, the encoder section 202 encodes the image data of the processing target picture by using the LFR target bit rate, which is determined in Step S201, as described with reference to the flowchart of FIG. 16.

In Step S204, the picture selecting section 211 determines if the processing target picture is a picture of LFR. If it is determined that the processing target picture is a picture of LFR, the process proceeds to Step S205.

In Step S205, the LFR rate controlling section 212 outputs the encoded data of a processing target picture as LFR encoded data.

In Step S206, the HFR rate controlling section 213 controls the bit rate of encoded data of a processing target picture such that the bit rate of encoded data of a processing target picture comes close to the HFR target bit rate, which is determined in Step S201.

In Step S207, the HFR rate controlling section 213 outputs the encoded data of the processing target picture, of which bit rate is controlled in the process of Step S206, as HFR encoded data.

When the process of Step S207 is finished, the process proceeds to Step S217.

Further, if it is determined that the processing target picture is not a picture of LFR in Step S204, the process proceeds to Step S208.

In Step S208, the HFR rate controlling section 213 controls the bit rate of the encoded data of the processing target picture such that the bit rate of encoded data of the processing target picture comes close to the HFR target bit rate, which is determined in Step S201.

In Step S209, the HFR rate controlling section 213 outputs the encoded data of the processing target picture, of which bit rate is controlled in the process of Step S208, as HFR encoded data.

When the process of Step S209 is finished, the process proceeds to Step S217.

Further, if it is determined that the target bit rate of LFR is lower than the target bit rate of HFR in Step S202, the process proceeds to Step S210.

In Step S210, the encoder section 202 encodes the image data of the processing target picture by using the HFR target bit rate, which is determined in Step S201, as described with reference to the flowchart of FIG. 16.

In Step S211, the picture selecting section 211 determines if the processing target picture is a picture of LFR. If it is determined that the processing target picture is a picture of LFR, the process proceeds to Step S212.

In Step S212, the LFR rate controlling section 212 controls the bit rate of the encoded data of the processing target picture such that the bit rate of encoded data of the processing target picture comes close to the LFR target bit rate, which is determined in Step S201.

In Step S213, the LFR rate controlling section 212 outputs the encoded data of the processing target picture as LFR encoded data. The bit rate of the encoded data of the processing target picture is controlled in the process of Step S212.

When the process of Step S213 is finished, the process proceeds to Step S217.

Further, if it is determined that the processing target picture is not a picture of LFR in Step S211, the process proceeds to Step S214.

In Step S214, the HFR rate controlling section 213 outputs encoded data of the processing target picture as HFR encoded data.

In Step S215, the LFR rate controlling section 212 controls the bit rate of encoded data of the processing target picture such that the bit rate of encoded data of the processing target picture comes close to the LFR target bit rate, which is determined in Step S201.

In Step S216, the LFR rate controlling section 212 outputs the encoded data of the processing target picture as LFR encoded data. The bit rate of the encoded data of the processing target picture is controlled in the process of Step S215.

After the process of Step S216 is finished, the process proceeds to Step S217.

In Step S217, the picture selecting section 102 determines if all the pictures are processed or not. If it is determined that there is an unprocessed picture, the process returns to Step S202. That is, the process of Step S202 to the process of Step S216 (except for some processes, which are not selected at the branches) are executed for each picture.

Note that, in a case where the target bit rate is changed for each picture, the loop process may include Step S201. In this case, if it is determined that there is an unprocessed picture in Step S217, the process returns to Step S201.

If it is determined that all the pictures are processed in Step S217, the plural FRs encoding process is finished.

By executing the respective processes as described above, the image encoding apparatus 200 is capable of creating encoded data of a plurality of kinds of frame rates from one piece of moving image data easily.

### 3. Third Embodiment

[3-1 Image Decoding Apparatus]

Note that the rate control with respect to encoded data, which is described in the second embodiment, may be executed at any stage. That is, for example, the similar rate control may be executed with respect to encoded data, which is yet to be decoded by an image decoding apparatus. Hereinafter, such a case will be described.

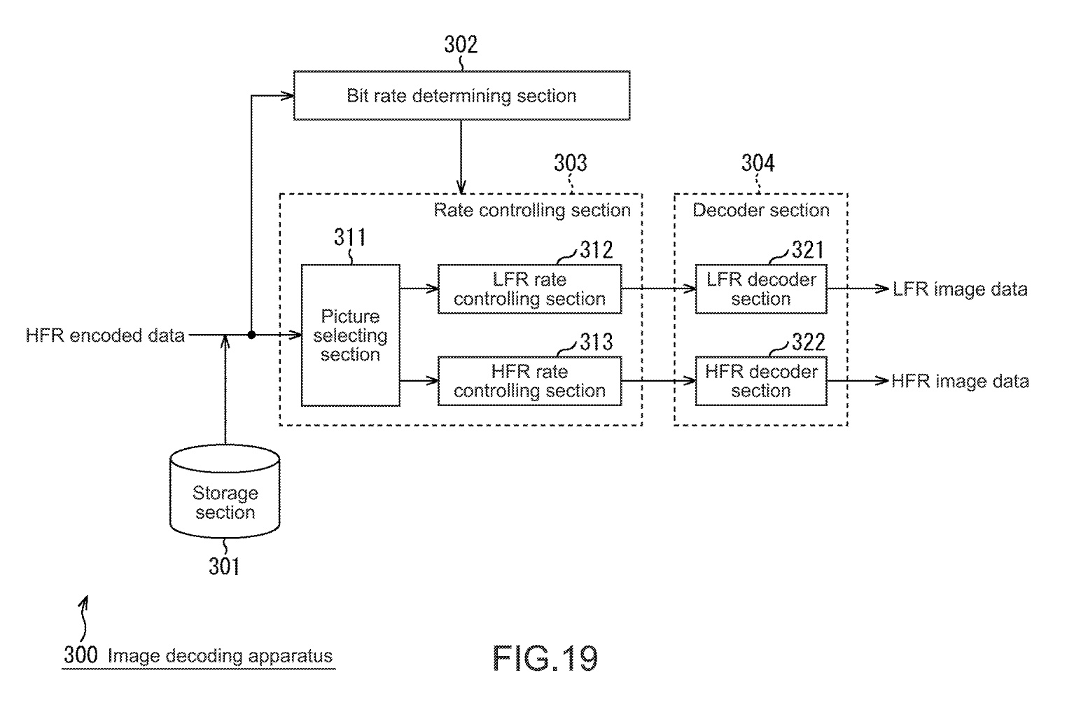

FIG. 19 is a block diagram showing a main configuration example of an image decoding apparatus. An image encoding apparatus 300 of FIG. 19 is an image processing apparatus, to which the present technology is applied. The image encoding apparatus 300 is configured to create encoded data of a plurality of frame rates from one piece of image data, and further configured to decode the created encoded data.

Encoded data input in the image decoding apparatus 300 or encoded data stored in storage section 301 is encoded data (HFR encoded data). Here, the encoded data (HFR encoded data) is obtained by encoding image data of a high bit frame (HFR) having a predetermined bit rate. The image decoding apparatus 300 decodes the HFR encoded data. The image decoding apparatus 300 creates image data (HFR image data) of HFR, and image data (LFR image data) of a low bit frame (LFR). Here, the low bit frame (LFR) has a predetermined bit rate, which is lower than the bit rate of HFR. The image decoding apparatus 300 outputs the HFR image data and the LFR image data.

At this time, the image decoding apparatus 300 controls the bit rate of HFR encoded data such that the bit rate of HFR encoded data comes close to the HFR target bit rate. In addition, the image decoding apparatus 300 controls the bit rate of the LFR encoded data such that the bit rate of the LFR encoded data comes close to the LFR target bit rate. As a result, the image decoding apparatus 300 is capable of obtaining a plurality of pieces of image data having desired bit rates and desired frame rates.

Note that, hereinafter, similar to the case described with reference to FIG. 2, frames of HFR include all the frames of LFR. Further, encoded data, which is input in the image decoding apparatus 300, is encoded by means of the encoding system (for example, JPEG 2000 system), which is executed by the image encoding apparatus 100 and the image encoding apparatus 200.

As shown in FIG. 19, the image decoding apparatus 300 includes the storage section 301, a bit rate determining section 302, a rate controlling section 303, and a decoder section 304.

The storage section 301 stores encoded data, which is obtained by encoding image data. The storage section 301 supplies the stored encoded data to the bit rate determining section 302 and the rate controlling section 303 at predetermined timing or as required. The storage section 301 may store encoded data, which is input in the image decoding apparatus 300. Alternatively, the storage section 301 may store encoded data previously.

The bit rate determining section 302 obtains encoded data, which is input in the image decoding apparatus 300, or encoded data, which is read from the storage section 301. The bit rate determining section 302 determines an HFR bit rate and an LFR bit rate of each encoded data.

The bit rate determining section 302 supplies control information to the rate controlling section 303. The control information shows the determined bit rates. The bit rate determining section 302 controls behaviors of the rate controlling section 303.

The rate controlling section 303 creates LFR encoded data based on the supplied HFR encoded data. The rate controlling section 303 controls the bit rate of the HFR encoded data such that the bit rate of the HFR encoded data comes close to HFR target bit rate, which is determined by the bit rate determining section 302. In addition, the rate controlling section 303 controls the bit rate of the created LFR encoded data such that the bit rate of the created LFR encoded data comes close to LFR target bit rate, which is determined by the bit rate determining section 302.

As shown in FIG. 19, the rate controlling section 303 includes a picture selecting section 311, an LFR rate controlling section 312, and an HFR rate controlling section 313.

The picture selecting section 311 detects and extracts data of frames of LFR, from the supplied HFR encoded data. The picture selecting section 311 supplies the extracted data (data of some frames) to the LFR rate controlling section 312 as LFR encoded data.

Note that, in addition, the picture selecting section 311 supplies the supplied HFR encoded data (data of all frames) to the HFR rate controlling section 313.

The LFR rate controlling section 312 controls the bit rate of encoded data of LFR, which is supplied from the picture selecting section 311. Specifically, the LFR rate controlling section 312 controls the bit rate of encoded data of LFR such that the bit rate of encoded data of LFR comes close to the LFR target bit rate, which is determined by the bit rate determining section 302. The LFR rate controlling section 312 supplies the LFR encoded data, of which bit rate is controlled, to the decoder section 304.

The HFR rate controlling section 313 controls the bit rate of HFR encoded data, which is supplied from the picture selecting section 311. Specifically, the HFR rate controlling section 313 controls the bit rate of HFR encoded data such that the bit rate of HFR encoded data comes close to the HFR target bit rate, which is determined by the bit rate determining section 302. The HFR rate controlling section 313 supplies the HFR encoded data, of which bit rate is controlled, to the decoder section 304.

The decoder section 304 decodes the encoded data (LFR encoded data and HFR encoded data), which is supplied from the rate controlling section 303 (LFR rate controlling section 312 and HFR rate controlling section 313).

As shown in FIG. 19, the decoder section 304 includes an LFR decoder section 321 and an HFR decoder section 322. The LFR decoder section 321 decodes LFR encoded data, which is supplied from the LFR rate controlling section 312, by means of a method corresponding to the encoding system. For example, the LFR decoder section 321 decodes LFR encoded data, which is encoded based on JPEG 2000 system, by means of JPEG 2000 system, to thereby create image data. The LFR decoder section 321 outputs the created image data (LFR image data) to the outside of the image decoding apparatus 300. Note that the LFR decoder section 321 may store the image data in the storage section 301.

The HFR decoder section 322 decodes the HFR encoded data, which is supplied from the HFR rate controlling section 313, by means of a method corresponding to the encoding system. For example, the HFR decoder section 322 decodes the HFR encoded data, which is encoded based on JPEG 2000 system, by means of JPEG 2000 system, to thereby create image data. The HFR decoder section 322 outputs the created image data (HFR image data) to the outside of the image decoding apparatus 300. Note that the HFR decoder section 322 may store the image data in the storage section 301.

[3-2 Decoder Section]

Next, the decoder section 304 (LFR decoder section 321 and HFR decoder section 322) of FIG. 19 will be described.

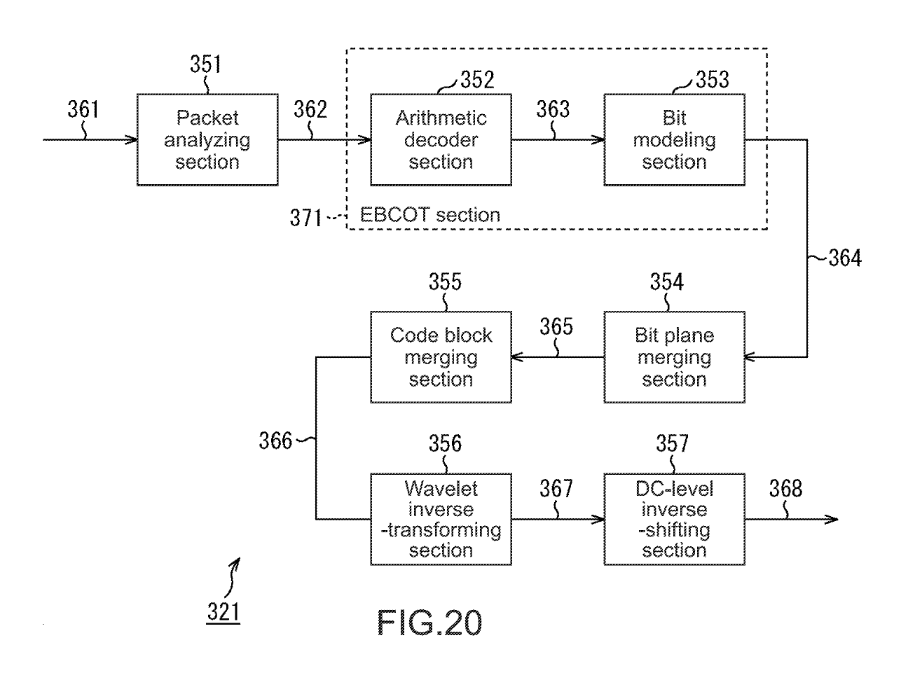

FIG. 20 is a diagram showing a main configuration example of the LFR decoder section 321. Note that the HFR decoder section 322 decodes frames, which are different from frames decoded by the LFR decoder section 321. Target bit rate of frames, which are decoded by the HFR decoder section 322, may be different from the target bit rate of frames, which are decoded by the LFR decoder section 321. The HFR decoder section 322 basically has a configuration similar to the configuration of the LFR decoder section 321. Process executed by the HFR decoder section 322 is similar to process executed by the LFR decoder section 321. In view of this, hereinafter, the configuration of the LFR decoder section 321 will be described. What is described about the LFR decoder section 321 will be applied to the HFR decoder section 322. Description of the HFR decoder section 322 will be omitted.

As shown in FIG. 20, the LFR decoder section 321 includes a packet analyzing section 351, an arithmetic decoder section 352, a bit modeling section 353, a bit plane merging section 354, a code block merging section 355, a wavelet inverse-transforming section 356, and a DC-level inverse-shifting section 357.

The packet analyzing section 351 analyzes packets, which are supplied from the outside or is read from the storage section 301 (arrow 361). The packet analyzing section 351 supplies a code stream to the arithmetic decoder section 352 (arrow 362).

The arithmetic decoder section 352 and the bit modeling section 353 function as an EBCOT section 371. The EBCOT section 371 performs entropy decoding called EBCOT, for example, with respect to an input code stream. EBCOT is specified by JPEG 2000 standard.

The arithmetic decoder section 352 decodes the code stream by means of a method corresponding to the arithmetic-coding section 137. The arithmetic decoder section 352 supplies context to the bit modeling section 353 (arrow 363). The bit modeling section 353 creates a wavelet coefficient, which is expanded into bit planes, by means of a method corresponding to the bit modeling section 136. The bit modeling section 353 supplies coefficient data for each created bit plane to the bit plane merging section 354 (arrow 364).

The bit plane merging section 354 merges the wavelet coefficient, which is expanded into bit planes. The bit plane merging section 354 supplies a wavelet coefficient, of which bit planes are merged, to the code block merging section 355 (arrow 365).

The code block merging section 355 creates coefficient data for each code block by using the supplied bit plane. Further, the code block merging section 355 merges the coefficient data, to thereby create coefficient data for each subband. The code block merging section 355 supplies the coefficient data to the wavelet inverse-transforming section 356 (arrow 366).

The wavelet inverse-transforming section 356 wavelet inverse-transforms the supplied wavelet coefficient, to thereby create baseband image data. The wavelet inverse-transforming section 356 supplies the created baseband image data to the DC-level inverse-shifting section 357 (arrow 367).

The DC-level inverse-shifting section 357 performs DC-level inverse-shifting process with respect to a DC component of the image data, as necessary. According to the DC-level inverse-shifting process, the DC-level inverse-shifting section 357 turns the DC component, which is shifted by the DC-level shifting section 131, back. The DC-level inverse-shifting section 357 outputs image data (decoded image data) after the DC-level inverse-shifting process, to the outside of the image decoding apparatus 300 (arrow 368).

By decoding encoded data as described above, the image decoding apparatus 300 is capable of creating encoded data of a plurality of kinds of frame rates from one piece of encoded data easily.

[3-3 Processing Flow]

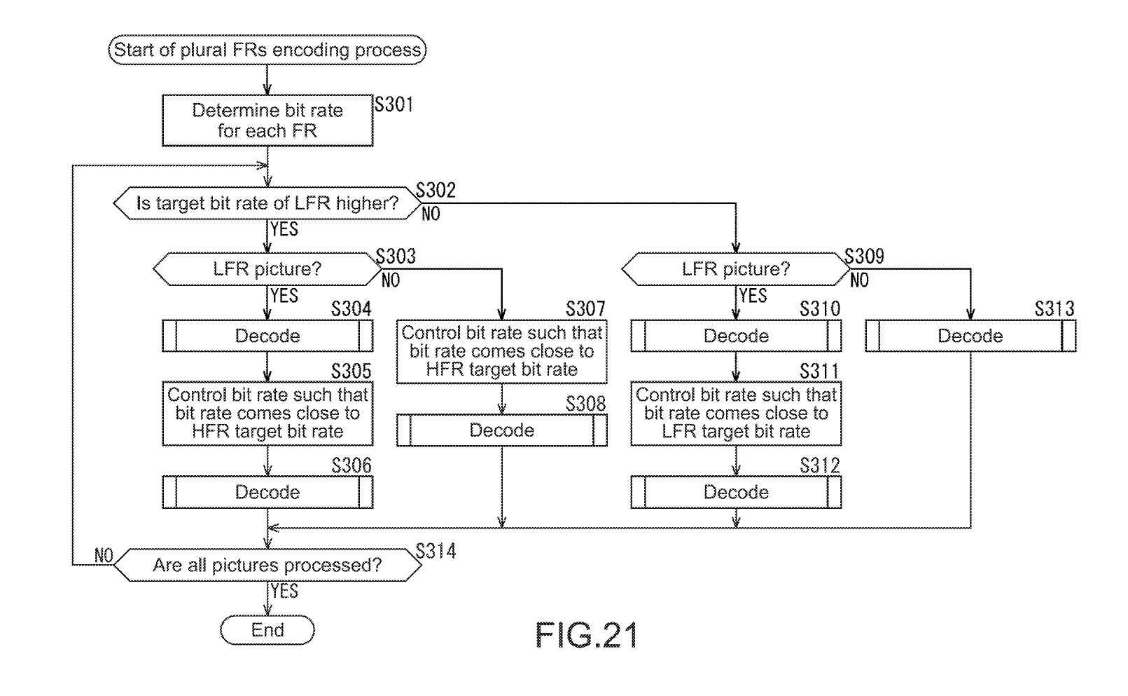

Next, processing flows executed by the image decoding apparatus 300 will be described. First, with reference to the flowchart of FIG. 21, the flow of the plural FRs decoding process will be described.

When the plural FRs decoding process is started, in Step S301, the bit rate determining section 302 determines a target bit rate for each frame rate (FR) based on header information of supplied HFR encoded data, based on an instruction from a user, and the like, for example.

In Step S302, the picture selecting section 311 determines if the target bit rate of LFR is higher than the target bit rate of HFR or not. If it is determined that the target bit rate of LFR is higher than the target bit rate of HFR, the process proceeds to Step S303.

In Step S303, the picture selecting section 311 determines if the processing target picture is a picture of LFR. If it is determined that the processing target picture is a picture of LFR, the process proceeds to Step S304.

In Step S304, the LFR decoder section 321 decodes encoded data of the processing target picture. The decoding process will be described later in detail. The LFR decoder section 321 outputs the LFR image data obtained as described above.

In Step S305, the HFR rate controlling section 313 controls encoded data of the processing target picture such that the bit rate of the encoded data of the processing target picture comes close to HFR target bit rate, which is determined in Step S301.

In Step S306, the HFR decoder section 322 decodes encoded data of the processing target picture. The decoding process will be described later in detail. The HFR decoder section 322 outputs HFR image data obtained as described above.

After the process of Step S306 is finished, the process proceeds to Step S314.

Further, if it is determined that the processing target picture is not a picture of LFR in Step S303, the process proceeds to Step S307.

In Step S307, the HFR rate controlling section 313 controls encoded data of the processing target picture such that the bit rate of the encoded data of the processing target picture comes close to HFR target bit rate, which is determined in Step S301.

In Step S308, the HFR decoder section 322 decodes the encoded data of the processing target picture. The decoding process will be described later in detail. The HFR decoder section 322 outputs HFR image data obtained as described above.

Further, if it is determined that the target bit rate of LFR is lower than the target bit rate of HFR in Step S302, the process proceeds to Step S309.

In Step S309, the picture selecting section 311 determines if the processing target picture is a picture of LFR or not. If it is determined that the processing target picture is a picture of LFR, the process proceeds to Step S310.

In Step S310, the HFR decoder section 322 decodes encoded data of the processing target picture. The decoding process will be described later in detail. The HFR decoder section 322 outputs the HFR image data obtained as described above.

In Step S311, the LFR rate controlling section 312 controls encoded data of the processing target picture such that the bit rate of the encoded data of the processing target picture comes close to LFR target bit rate, which is determined in Step S301.

In Step S312, the LFR decoder section 321 decodes encoded data of the processing target picture. The decoding process will be described later in detail. The LFR decoder section 321 outputs the LFR image data obtained as described above.

After the process of Step S312 is finished, the process proceeds to Step S314.

Further, if it is determined that the processing target picture is not a picture of LFR in Step S309, the process proceeds to Step S313.

In Step S313, the HFR decoder section 322 decodes encoded data of the processing target picture. The decoding process will be described later in detail. The HFR decoder section 322 outputs the HFR image data obtained as described above.

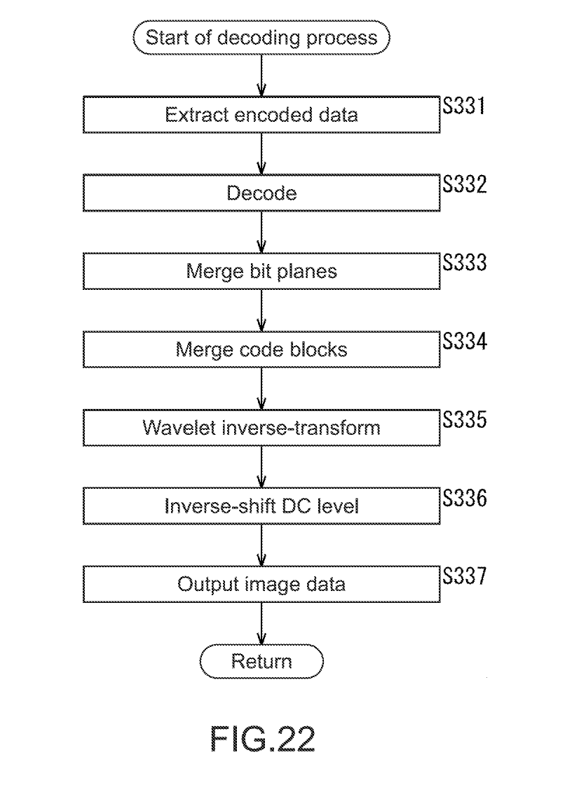

Next, with reference to the flowchart of FIG. 22, an example of the flow of the decoding process, which is executed in Step S304, Step S308, Step S310, Step S312, or Step S313 of FIG. 21, will be described in detail.

When the decoding process is started, in Step S331, the packet analyzing section 351 extracts encoded data from the obtained packet.

In Step S332, the EBCOT section 371 decodes the encoded data extracted in Step S331. In Step S333, the bit plane merging section 354 merges bit planes of coefficient data obtained by decoding, to thereby create coefficient data for each code block. In Step S334, the code block merging section 355 merges code blocks of the coefficient data for each code block, to thereby create coefficient data for each subband.

In Step S335, the wavelet inverse-transforming section 356 wavelet inverse-transforms the coefficient data for each subband, to thereby create baseband image data. Note that, in a case where coefficient data is quantized, first, the wavelet inverse-transforming section 356 inverse-quantizes coefficient data by means of an inverse-quantizing method corresponding to the quantization. Then, the wavelet inverse-transforming section 356 wavelet inverse-transforms the coefficient data for each subband.

In Step S336, the DC-level inverse-shifting section 357 inverse-shifts the DC level of baseband image data, which is obtained by wavelet inverse-transformation.

In Step S337, the DC-level inverse-shifting section 357 outputs image data, which is DC-level inverse-shifting processed, as decoded image data. For example, the DC-level inverse-shifting section 357 outputs the decoded image data to a display device (not shown). The display device displays the image.

After the process of Step S337 is finished, the decoding process is finished. The process returns to Step S304, Step S308, Step S310, Step S312, or Step S313 of FIG. 21.

By executing the respective processes as described above, the image decoding apparatus 300 is capable of creating decoded data of a plurality of kinds of frame rates from one piece of encoded data easily.

### 4. Fourth Embodiment

[4-1 Layer Control]

Note that the present technology may control bit rates easily by using the layers shown in FIG. 12.

For example, in (Case-1) of the first embodiment, a bit rate of each layer is set as follows.

Layer 1 to layer M: Bit_HFR (8.33 Mbits/pic)

Layer 1 to layer L: Bit_LFR (10.42 Mbits/pic)

That is, layers are set when encoding such that the above-mentioned bit rates are set. Because of this, in a case of reducing a bit rate to a lower bit rate when controlling a rate, layers from the layer M to the layer L may be rounded down. The same applies to (Case-2).

[4-2 Information Transmittance]

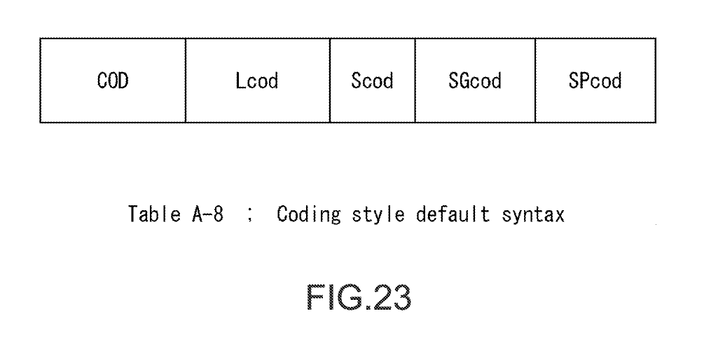

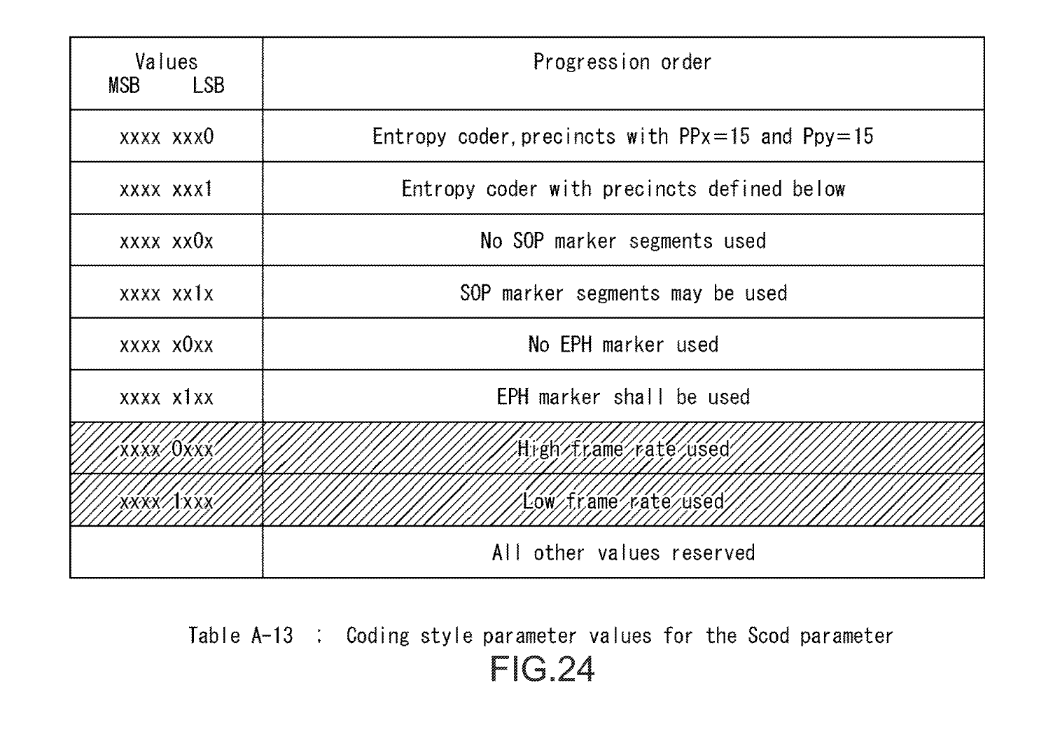

A flag for identifying a picture of LFR or a picture of HFR may be defined in a JPEG 2000-encoded code stream. In this case, an unused bit of a marker segment in a picture header of JPEG 2000 may be used. For example, FIG. 23 shows an example of a COD marker segment. FIG. 24 shows an example of an Scod parameter in the COD marker.

In the table of FIG. 24, the second to seventh parameters from the top are already defined in JPEG 2000 Part 1. Because of this, the bits for the second to seventh parameters may not be used. In view of this, as shown in the hatched part of the table of FIG. 24, an LFR picture and an HFR picture may be defined and identified as follows.

xxxx 0xxx High frame rate used

xxxx 0xxx Low frame rate used

Alternatively, blank bits in a picture header may be used. It is needless to say that the similar effect is obtained as the result.

Note that the present technology may be applied to an apparatus configured to encode moving image signals at a conventional low frame rate (LFR: for example, 24 P) and in addition at a high frame rate (HFR: for example, 48 P, 60 P, etc.) simultaneously, for the purpose of digital cinema and the like. Examples of such an apparatus include, for example, an encoder apparatus for digital cinema, an editing apparatus for digital cinema, an archive system, an image transmitting apparatus at a broadcast station, an image database, a recording system for medical images, a game machine, a television receiver system, a Blu Ray Disc recorder/player, a free viewpoint television, an ambience TV conference system, a PC authoring tool, a PC authoring software module, and the like.

### 5. Fifth Embodiment

[Computer]

Any one of hardware and software may execute the above-mentioned series of processes. If software executes the series of processes, a program structuring the software is installed in a computer. Here, the computer may be a computer mounted on dedicated hardware, a general-purpose personal computer, for example, in which various programs are installed and which is thus configured to execute various functions, or the like.

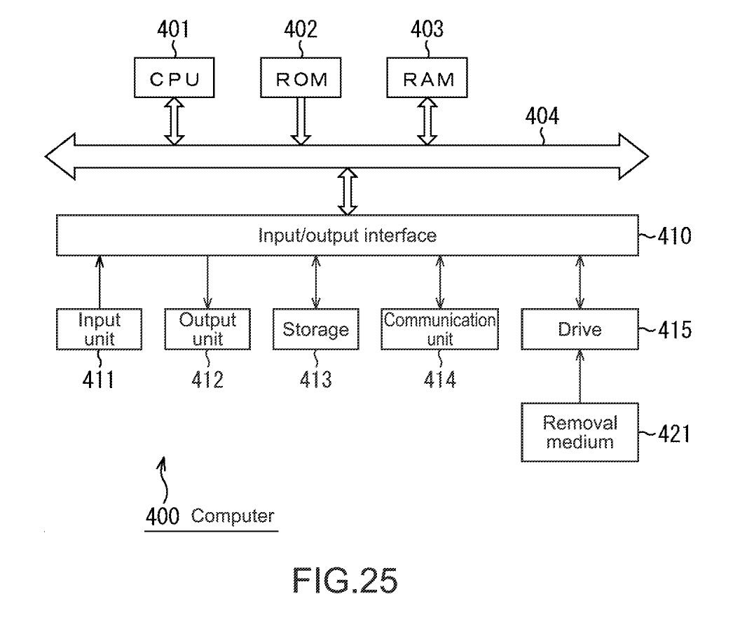

FIG. 25 is a block diagram showing a configuration example of hardware of a computer, which executes the above-mentioned series of processes by means of a program.

A computer 400 of FIG. 25 includes a CPU (Central Processing Unit) 401, a ROM (Read Only Memory) 402, and a RAM (Random Access Memory) 403, which are connected to each other by a bus 404.

An input/output interface 410 is also connected to the bus 404. An input unit 411, an output unit 412, storage 413, a communication unit 414, and a drive 415 are connected to the input/output interface 410.

The input unit 411 includes, for example, a keyboard, a mouse, a microphone, a touchscreen, an input terminal, and the like. The output unit 412 includes, for example, a display, a speaker, an output terminal, and the like. The storage 413 includes, for example, a hard disk, a RAM disk, a nonvolatile memory, and the like. The communication unit 414 includes, for example, a network interface. The drive 415 drives a removal medium 421. The removal medium 421 includes a magnetic disk, an optical disk, a magnet-optical disk, a semiconductor memory, or the like.

In the thus-structured computer, for example, the CPU 401 loads a program stored in the storage 413 in the RAM 403 via the input/output interface 410 and the bus 404. As a result, the computer executes the above-mentioned series of processes. Further, the RAM 403 as necessary stores data and the like, which are necessary to execute various processes by the CPU 401.

A program executed by the computer (CPU 401) may be recorded in the removal medium 421 as a package medium or the like, for example, and may be used. Alternatively, the program may be provided to the computer via a wired or wireless transmitting medium such as a local area network, the Internet, or digital satellite broadcasting.

The removal medium 421 is mounted on the drive 415 of the computer, and the program may thus be installed in the storage 413 via the input/output interface 410. Alternatively, the communication unit 414 may receive the program via a wired or wireless transmitting medium, and the program may be installed in the storage 413. Alternatively, the program may be preinstalled in the ROM 402 or the storage 413.

Note that the program executed by a computer may be sequentially processed in the order described in this specification, may be processed in parallel, or may be processed at necessary timing, for example, when the program is called.

Further, in this specification, the step of describing a program, which is recorded in a recording medium, includes, as a matter of course, processes sequentially processed in the described order, and processes which are not processed sequentially. The latter includes processes executed in parallel, and processes executed separately.

Further, in this specification, the term “system” means a set of a plurality of functional elements (apparatuses, modules (components), etc.). It is not the important if all the functional elements are accommodated in one case or not. That is, the “system” includes a plurality of apparatuses, which are accommodated in different cases, and which are connected to each other via a network. The “system” also includes an apparatus, which includes a plurality of modules accommodated in one case.

Further, the above-mentioned configuration of one apparatus (or processing section) may be divided, and a plurality of apparatuses (or processing sections) may thus be configured. To the contrary, the above-mentioned configuration of a plurality of apparatuses (or processing sections) may be included in one apparatus (or processing section). Further, as a matter of course, the configuration of each apparatus (or each processing section) may include a configuration, which is not described above. Further, as long as the configuration and the behaviors of the entire system are not changed substantially, the configuration of one apparatus (or one processing section) may include a part of the configuration of another apparatus (or another processing section).

The Embodiments of the present disclosure have been described above in detail with reference to the attached drawings. The technical scope of the present disclosure is not limited to those examples. It should be understood by those skilled in the art that various modifications, combinations, sub-combinations and alterations may occur depending on design requirements and other factors insofar as they are within the scope of the appended claims or the equivalents thereof.

For example, the present technology may employ the configuration of cloud computing, in which a plurality of apparatuses share one function and process the function together via a network.

Further, one apparatus may execute the steps described with reference to the flowcharts, or a plurality of apparatuses may share and execute the steps.

Further, in a case where one step includes a plurality of processes, one apparatus may execute the plurality of processes in the step, or a plurality of apparatuses may share and execute the plurality of processes.

Note that the present technology may employ the following configurations.

(1) An image processing apparatus, comprising:

a first encoder section configured to encode some frames of image data, to thereby create first encoded data;

a rate controlling section configured to control a bit rate of the first encoded data created by the first encoder section, to thereby create low-frame-rate encoded data having a first bit rate and second encoded data having a second bit rate, the second bit rate being different from the first bit rate;

a second encoder section configured to encode the frames of the image data, the frames being other than the frames encoded by the first encoder section, to thereby create third encoded data having the second bit rate; and

an integrating section configured to integrate the second encoded data created by the rate controlling section and the third encoded data created by the second encoder section, to thereby create high-frame-rate encoded data.

(2) The image processing apparatus according to (1), wherein

the bit rate is a bit amount for each frame.

(3) The image processing apparatus according to (2), wherein

the rate controlling section is configured to as necessary round down a part of the first encoded data of each frame, to thereby control the bit amount for each frame.

(4) The image processing apparatus according to (3), wherein

the rate controlling section is configured to round down a the first encoded data of each frame by a necessary amount from the least important side in the ascending order.

(5) The image processing apparatus according to (4), wherein

the first encoder section includes
a transforming section configured to transform the image data of a part of frame into coefficient data for each frequency band, and
a bit plane encoder section configured to encode the coefficient data obtained by the transforming section for each bit plane, the bit plane being created for a predetermined number of pieces of the coefficient data, the bit plane being a set of values at the same bit position, and

the rate controlling section is configured to round down a necessary number of bit planes of the first encoded data from the bottom in ascending order.

(6) The image processing apparatus according to (5), wherein
the first encoder section further includes
a code-block creating section configured to create a code block, the code block including a predetermined number of pieces of the coefficient data obtained by the transforming section, and
a bit-plane creating unit configured to create the bit plane for each code block created by the code-block creating section, and

the bit plane encoder section is configured to round down a necessary number of bit planes of the code block created by the bit-plane creating unit from the bottom in ascending order.

(7) The image processing apparatus according to (6), wherein

the second encoder section is configured to encode the image data by means of an encoding system similar to the first encoder section.

(8) The image processing apparatus according to (7), wherein

each of the first encoder section and the second encoder section is configured to encode frames of the image data by means of JPEG 2000 system.

(9) The image processing apparatus according to any one of (1) to (8), wherein

the first encoder section is configured to set a layer of a coding pass based on the first bit rate and the second bit rate, and

the rate controlling section is configured to round down a necessary number of layers, to thereby control a bit rate of the first encoded data, and to thereby create the low-frame-rate encoded data and the second encoded data.

(10) The image processing apparatus according to any one of (1) to (9), further comprising:

a frame distributing section configured
to distribute some frames of the image data to the first encoder section based on a preset frame rate, and
to distribute the other frames to the second encoder section.
   (11) The image processing apparatus according to (10), wherein

the frame distributing section is configured to add identification information to at least one of the frames distributed to the first encoder section and the frames distributed to the second encoder section, the identification information identifying a distribution-target group.

(12) The image processing apparatus according to any one of (1) to (11), further comprising:

storage configured to store the low-frame-rate encoded data created by the rate controlling section.

(13) An image processing method performed by an image processing apparatus, comprising:

by the image processing apparatus,

encoding some frames of image data, to thereby create first encoded data;

controlling a bit rate of the created first encoded data, to thereby create low-frame-rate encoded data having a first bit rate and second encoded data having a second bit rate, the second bit rate being different from the first bit rate;

encoding the other frames of the image data, to thereby create third encoded data having the second bit rate; and

integrating the created second encoded data and the created third encoded data, to thereby create high-frame-rate encoded data.

(14) A program, configured to cause a computer to function as:

a first encoder section configured to encode some frames of image data, to thereby create first encoded data;

a rate controlling section configured to control a bit rate of the first encoded data created by the first encoder section, to thereby create low-frame-rate encoded data having a first bit rate and second encoded data having a second bit rate, the second bit rate being different from the first bit rate;

a second encoder section configured to encode the frames of the image data, the frames being other than the frames encoded by the first encoder section, to thereby create third encoded data having the second bit rate; and

an integrating section configured to integrate the second encoded data created by the rate controlling section and the third encoded data created by the second encoder section, to thereby create high-frame-rate encoded data.

(15) An image processing apparatus, comprising:

a selecting section configured to select data for each frame from encoded data at a ratio corresponding to a frame rate, the encoded data being obtained by encoding image data, to thereby create encoded data of a plurality of frame rates; and

a rate controlling section configured to use each target bit rate as a bit rate of encoded data of each frame rate, the encoded data being created by the selecting section.

(16) The image processing apparatus according to (15), further comprising:

a determining section configured to determine the target bit rate, wherein

the rate controlling section is configured to use a bit rate of encoded data of each frame rate as a target bit rate determined by the determining section.

(17) The image processing apparatus according to (15) or (16), further comprising:

an encoder section configured to encode the image data, to thereby create the encoded data, wherein

the selecting section is configured to create encoded data of a plurality of frame rates from the encoded data created by the encoder section.

(18) The image processing apparatus according to any one of (15) to (17), further comprising:

a decoder section configured to decode encoded data of each frame rate, the each frame rate being controlled at each target bit rate by the rate controlling section.

(19) An image processing method performed by an image processing apparatus, comprising:

by the image processing apparatus,

selecting data for each frame from encoded data at a ratio corresponding to a frame rate, the encoded data being obtained by encoding image data, to thereby create encoded data of a plurality of frame rates; and

using each target bit rate as a bit rate of the created encoded data of each frame rate.

(20) A program, configured to cause a computer to function as:

a selecting section configured to select data for each frame from encoded data at a ratio corresponding to a frame rate, the encoded data being obtained by encoding image data, to thereby create encoded data of a plurality of frame rates; and

a rate controlling section configured to use each target bit rate as a bit rate of encoded data of each frame rate, the encoded data being created by the selecting section.

The present disclosure contains subject matter related to that disclosed in Japanese Priority Patent Application JP 2012-114679 filed in the Japan Patent Office on May 18, 2012, the entire content of which is hereby incorporated by reference.

What is claimed is:

1. An image processing apparatus, comprising:
a first encoder section configured to encode some frames of image data, to thereby create first encoded data;
a rate controlling section configured to control a bit rate of the first encoded data created by the first encoder section, to thereby create low-frame-rate encoded data having a first bit rate and second encoded data having a second bit rate, the second bit rate being different from the first bit rate;
a second encoder section configured to encode the frames of the image data, the frames being other than the frames encoded by the first encoder section, to thereby create third encoded data having the second bit rate; and
an integrating section configured to integrate the second encoded data created by the rate controlling section and the third encoded data created by the second encoder section, to thereby create high-frame-rate encoded data.

2. The image processing apparatus according to claim 1, wherein
the bit rate is a bit amount for each frame.

3. The image processing apparatus according to claim 2, wherein
the rate controlling section is configured to as necessary round down a part of the first encoded data of each frame, to thereby control the bit amount for each frame.

4. The image processing apparatus according to claim 3, wherein
the rate controlling section is configured to round down a the first encoded data of each frame by a necessary amount from the least important side in the ascending order.

5. The image processing apparatus according to claim 4, wherein
the first encoder section includes
a transforming section configured to transform the image data of a part of frame into coefficient data for each frequency band, and
a bit plane encoder section configured to encode the coefficient data obtained by the transforming section for each bit plane, the bit plane being created for a predetermined number of pieces of the coefficient data, the bit plane being a set of values at the same bit position, and
the rate controlling section is configured to round down a necessary number of bit planes of the first encoded data from the bottom in ascending order.

6. The image processing apparatus according to claim 5, wherein
the first encoder section further includes
a code-block creating section configured to create a code block, the code block including a predetermined number of pieces of the coefficient data obtained by the transforming section, and
a bit-plane creating unit configured to create the bit plane for each code block created by the code-block creating section, and
the bit plane encoder section is configured to round down a necessary number of bit planes of the code block created by the bit-plane creating unit from the bottom in ascending order.

7. The image processing apparatus according to claim 6, wherein
the second encoder section is configured to encode the image data by means of an encoding system similar to the first encoder section.

8. The image processing apparatus according to claim 7, wherein
each of the first encoder section and the second encoder section is configured to encode frames of the image data by means of JPEG 2000 system.

9. The image processing apparatus according to claim 1, wherein
the first encoder section is configured to set a layer of a coding pass based on the first bit rate and the second bit rate, and
the rate controlling section is configured to round down a necessary number of layers, to thereby control a bit rate of the first encoded data, and to thereby create the low-frame-rate encoded data and the second encoded data.

10. The image processing apparatus according to claim 1, further comprising:
a frame distributing section configured
to distribute some frames of the image data to the first encoder section based on a preset frame rate, and
to distribute the other frames to the second encoder section.

11. The image processing apparatus according to claim 10, wherein
the frame distributing section is configured to add identification information to at least one of the frames distributed to the first encoder section and the frames distributed to the second encoder section, the identification information identifying a distribution-target group.

12. The image processing apparatus according to claim 1, further comprising:
storage configured to store the low-frame-rate encoded data created by the rate controlling section.

13. An image processing method performed by an image processing apparatus, comprising:
by the image processing apparatus,
encoding some frames of image data, to thereby create first encoded data;
controlling a bit rate of the created first encoded data, to thereby create low-frame-rate encoded data having a first bit rate and second encoded data having a second bit rate, the second bit rate being different from the first bit rate;
encoding the other frames of the image data, to thereby create third encoded data having the second bit rate; and
integrating the created second encoded data and the created third encoded data, to thereby create high-frame-rate encoded data.

14. A program, configured to cause a computer to function as:
a first encoder section configured to encode some frames of image data, to thereby create first encoded data;
a rate controlling section configured to control a bit rate of the first encoded data created by the first encoder section, to thereby create low-frame-rate encoded data having a first bit rate and second encoded data having a second bit rate, the second bit rate being different from the first bit rate;
a second encoder section configured to encode the frames of the image data, the frames being other than the frames encoded by the first encoder section, to thereby create third encoded data having the second bit rate; and
an integrating section configured to integrate the second encoded data created by the rate controlling section and the third encoded data created by the second encoder section, to thereby create high-frame-rate encoded data.

15. An image processing apparatus, comprising:
a selecting section configured to select data for each frame from encoded data at a ratio corresponding to a frame rate, the encoded data being obtained by encoding image data, to thereby create encoded data of a plurality of frame rates; and
a rate controlling section configured to use each target bit rate as a bit rate of encoded data of each frame rate, the encoded data being created by the selecting section.

16. The image processing apparatus according to claim 15, further comprising:
a determining section configured to determine the target bit rate, wherein
the rate controlling section is configured to use a bit rate of encoded data of each frame rate as a target bit rate determined by the determining section.

17. The image processing apparatus according to claim 15, further comprising:
an encoder section configured to encode the image data, to thereby create the encoded data, wherein
the selecting section is configured to create encoded data of a plurality of frame rates from the encoded data created by the encoder section.

18. The image processing apparatus according to claim 15, further comprising:
a decoder section configured to decode encoded data of each frame rate, the each frame rate being controlled at each target bit rate by the rate controlling section.

19. An image processing method performed by an image processing apparatus, comprising:
by the image processing apparatus,
selecting data for each frame from encoded data at a ratio corresponding to a frame rate, the encoded data being obtained by encoding image data, to thereby create encoded data of a plurality of frame rates; and
using each target bit rate as a bit rate of the created encoded data of each frame rate.

20. A program, configured to cause a computer to function as:
a selecting section configured to select data for each frame from encoded data at a ratio corresponding to a frame rate, the encoded data being obtained by encoding image data, to thereby create encoded data of a plurality of frame rates; and
a rate controlling section configured to use each target bit rate as a bit rate of encoded data of each frame rate, the encoded data being created by the selecting section.
